(19) United States
(12) Patent Application Publication
(10) Pub. No.: US 2026/0225791 A1
(43) Pub. Date: Aug. 6, 2026

(54) CAPSULE FOR PREPARING A PREDETERMINED AMOUNT OF BEVERAGE SUITABLE FOR CONSUMPTION USING AN EXTRACTABLE PRODUCT

(71) Applicant: ILLYCAFFE' S.P.A., Trieste (IT)

(72) Inventors: Franciscus Benedictus Maria VAN EEDEN, Trieste (IT); Paola MUGGIA, Trieste (IT); Andrea GREPPI, Trieste (IT); Bruno DELLAPIETRA, Trieste (IT); Gabriele CAPRA, Trieste (IT); Alessandro BENEDETTI, Trieste (IT)

(21) Appl. No.: 19/154,504

(22) PCT Filed: Feb. 16, 2024
(86) PCT No.: PCT/IB2024/051488

§ 371 Date: Aug. 7, 2025

(30) Foreign Application Priority Data
Mar. 13, 2023 (IT) 102023000004641

(51) Int. Cl. B65D 85/804

(52) U.S. Cl. CPC B65D 85/8055; B65D 85/8064

(57) ABSTRACT

A capsule for preparing a predetermined amount of beverage suitable for consumption using an extractable product, optionally the extractable product being ground coffee, has a first half-capsule and a second half-capsule. Each half-capsule has a thin capsule wall that forms, in one piece, a first thin wall portion delimiting a substantially hemispherical inner half-chamber. The thin capsule wall, close to a greater dimension thereof forms, in one piece with the first thin wall portion, a second thin wall portion which bends to form an annular flange. The first and second half-capsules are arranged facing each other, mutually specular and are joined to each other. At least one of the annular flanges has a free flange end edge forming a flange ring having an overall ring thickness greater than a thickness of a portion of the annular flange placed in contact with the adjacent half-capsule.

### TECHNICAL FIELD OF THE INVENTION

The invention falls within the general technical field of disposable capsules for preparing beverages, preferably, but not exclusively, for preparing coffee, the product to be infused of which is arranged and remains used in the package which acts as an infusion chamber or is dissolved if it is a soluble extract.

More specifically, it relates to the technical field of capsules intended to be pierced to allow the injection of fluid, e.g., pressurized water, into the aforesaid capsule. The invention also relates to the technical field of methods allowing the infusion of such capsules.

### BACKGROUND ART

Disposable pods and capsules are well-known from the prior art and are described, for example, in WO 2004/006740 (SEB), WO 94/01344 (Nestlé), U.S. 2004/0197444 (Kraft Foods), U.S. Pat. No. 5,012,629 (Kraft Foods), WO 2004/087529 (Hausbrandt), EP 1,221,418 (Melitta Haushaltsprodukte), EP 1,295,554 (SGL Italia) and EP 0,583,210 (Fornari).

FR 2,879,175 (Luciani) shows a capsule comprising a packaging bag acting as an infusion chamber. Differently, a capsule is used only to convey a predetermined amount of a substance to be infused in a machine-specific infusion chamber. If the pod comprises a packaging casing, it only serves to protect the substance to be infused and must be removed beforehand in order to remove the aforesaid pod.

Sealed capsules adapted to be opened by the pressure of the injected water are particularly advantageous because they allow obtaining high-quality beverages.

In particular, a capsule is known from EP 0,554,469 (Nestlé), which is intended to be used in a machine for automatically preparing beverages, the aforesaid capsule being formed by a compacted aggregate of a substance to be infused contained in a packaging casing being impermeable to air and water and having the shape of a truncated cone.

In addition to hygiene reasons, the use of a packaging casing being impermeable to air and water offers the advantage of being capable of preserving the capsules for a relatively long period of time without deterioration of the taste and aromas of the beverage.

Moreover, the infusion of the beverage can be carried out directly in the capsule, the packaging casing acting as an infusion chamber.

A further feature of this capsule is that the packaging casing is configured to burst when pressurized water is injected into the aforesaid capsule. The package casing only bursts in a weakness zone provided at the base of the truncated cone.

Due to the shape and design thereof, such a capsule must be placed in the infusion chamber of an extraction machine in a specific position.

In fact, the infusion is carried out by a piercing device configured to pierce the upper part of the truncated cone and inject pressurized water. Under the effect of the pressure, the weakness zone arranged at the base of the truncated cone bursts and the water is infused through the capsule towards a conduit for recovering the infused substance and conveying it towards a container, such as a cup.

One disadvantage of this type of capsules is that they must be positioned so that the top of the truncated cone is opposite to the piercing device and that the weakness zone at the base of the truncated cone is opposite to the conduit for recovering the infused substance, where a different arrangement exposes the machine to the risk of damage.

Therefore, it is necessary to provide means for imposing the positioning of the capsule in the infusion chamber. The design of the machine becomes complex and it is not possible to provide a machine provided with a tank where the capsules would be stored in bulk and automatically conveyed to the infusion chamber.

WO2021205269A1 discloses a pod made of a compostable material for packaging foodstuff products comprising a coffee-based granular material and at least one binder selected from methylcellulose, derivatives of methylcellulose, and mixtures thereof. This pod has a lenticular and symmetrical shape with respect to a coupling plane of two body portions.

WO2011000724A1 discloses a capsule or lenticular pod having two walls mutually connected at a joint along a transverse median plane. The joint is made by sealing a peripherical portion of each wall. One similar solution is known from FR2912124A1, WO0228241A1,FR2930522, EP2750563B1 and U.S. Pat. No. 6,485,766.

WO02058522A2 discloses a cartridge comprising a cartridge inlet, a chamber connected to said cartridge inlet to contain suitable materials containing aromas or particles, a cartridge outlet connected to said chamber, and a handle which allows a user to connect and fix the cartridge inlet to the support to allow dispensing the pressurized liquid through the materials containing aromas or particles into the chamber, through the cartridge outlet and directly into a receptacle, such as a cup or a jug for consumption. This handle comprises at least one part of the chamber wall, which is rigid. The cartridge inlet has a cross-section area which is considerably smaller than that of the chamber to reduce the force applied by the liquid pressure at the cartridge inlet. The cartridge outlet has a narrowing opening as an orifice to form a high-speed jet or current of fluid and the possibility to interact with the air to generate a froth in the fluid dispensed.

EP2106375A2 discloses a capsule usable in any position in a machine for automatically preparing and dispensing beverages, where this machine is provided with a device for piercing the casing of the capsule and injecting pressurized water into said capsule. One feature of the capsule is that it does not require any pre-positioning in the infusion chamber of said machine. This capsule is to be used in a machine for automatically preparing and dispensing beverages and is formed by a compacted aggregate of a substance to be infused trapped in an airtight and watertight conditioning casing so that the infusion can be carried out inside said capsule. The conditioning casing has an essentially spherical outer shape and is adapted to be pierced on practically any portion of the surface thereof when water is injected into said capsule. Despite showing the overlapping of two half-casing edges, FIG. 1 does not disclose in this document the formation of any flange radially projecting from the sphere shape. Completely differently, this document highlights how it is absolutely necessary to suggest a spherical capsule that (quote) “can be substantially pierced on any part of the surface thereof, whatever the position of the latter with respect to the piercing and infusion device and the infused substance recovery device”. This aim of EP2106375A2 would be absolutely impossible if the capsule had a flange for the orientation of the capsule position. Similar solutions are known from FR2879175A1, DE29811729U1, FR1305737A, EP2575490B1, EP2598417B1, U.S. Pat. No. 1,931,765, EP3501345B1, FR3047159.

Despite being satisfactory from some points of view, these known solutions leave many needs unfulfilled. In particular, there is a need to have a capsule for supplying a single dose which has an optimized ratio between outer surface (package casing) and volume of contents (ingredient to form the beverage), while allowing a good handling and management both before and after use.

WO2022003526A1 shows a cone-shaped capsule and a method for producing this capsule. This capsule provides for the packaging casing to be configured to burst during the injection of pressurized water into said capsule. The packaging wall is pierced only at a weakening zone provided at the base of the truncated cone. Because of the shape and design thereof, such a capsule must be positioned in the infusion chamber in a specific position by virtue of the cone shape thereof. In fact, the infusion occurs by means of a piercing device configured to pierce the top of the truncated cone and inject pressurized water. The flange present in this solution is used to make a hydraulic seal, preferably in curl-shaped folds placed at the end of the flange.

### OBJECT AND SUMMARY OF THE INVENTION

Therefore, it is the object of the present invention to overcome the drawbacks of the prior art and allow having a capsule which minimizes the use of packaging material while having the maximum volume of material to form the beverage, and especially allowing an improved percolation of the fluid into the ingredient to form the beverage.

Moreover, it is the object of the present invention to use a capsule having at least one flange and at least one portion thereof with greater thickness to arrange and/or orient the capsule in a predetermined manner, for example inside an extraction chamber of a beverage extraction device or machine.

This and other objects are achieved by a capsule according to claim 1.

Some advantageous embodiments are the subject of the dependent claims.

In brief, an embodiment can be summarized in the provision of a capsule for preparing a predetermined amount of beverage suitable for consumption using an ingredient, i.e., an extractable product, e.g., ground coffee, comprising a first and a second half-capsule, where each half-capsule comprises a thin capsule wall. Said thin capsule wall forms in one piece a first thin wall portion delimiting a substantially hemispherical inner half-chamber. Said two half-capsules are arranged facing each other and mutually specular so as to contact at least a second portion thereof where they are mutually joined. Said first thin wall portions have substantially identical volume outlines. Said specularly facing first thin wall portions substantially form an outline with an overall substantially spherical volume with truncated poles.

By virtue of the general embodiment and variants described above and further described below, it is possible to obtain the following advantages.

By virtue of the suggested solutions, substantially by virtue of a spherical capsule with truncated poles, e.g., with the two poles, of the North-South type, which are substantially planar or slightly concave, it is possible to have a spherical shape which is used for the single doses of beverage, such as coffee, having the best ratio between outer surface (package casing) and content volume (ingredient to form the beverage) and, at the same time, an improved percolation of the fluid into the ingredient to form the beverage. In particular, the use of spherical compressed contents optimizes this ratio, minimizing the amount of material used for packaging the single dose. This reduces the environmental impact and ensures a high standard of quality of the beverage. The compressed contents in this spherical shape with truncated poles also reduces the fraction of incorporated air/gas with respect to the solid contents, improving the preservation of the single dose and limiting waste. Moreover, the solid contents contribute to the mechanical resistance of the single dose during packaging, transport and use. This mechanical resistance, together with the barrier to the oxygen and humidity of the casing, allows using a secondary light packaging, such as paper or cardboard, further reducing the environmental impact and the use of raw materials and energy.

The spherical capsule with truncated poles and compressed contents adhering to the inner wall (the ingredient) is an optimal solution for ensuring the integrity of the panel. The term “panel” is understood to mean the ingredient, or compressed, extractable product formed by granules, powder or similar mixtures, which are desirably left in this form until the time of use. The use of a spherical capsule with truncated poles prevents cracks in the panel, which can compromise the efficacy of the extraction (preferential flow routes of the extraction fluid) and ensures a quality percolation. On the contrary, packages with contents placed in flared shapes, such as cones or cylinders, can remain movable, or negatively affect the hydraulic resistance, which is important for pressurization during percolation.

How the resistance of the solid porous panel to hot or cold water, which contributes to the pressure thereof for a good percolation, depends on several factors. These include: the amount and compression of the ingredient or mixture, the length and tortuosity of the path of the water through the panel, the uniformity and distribution of the particles, the initial penetration of the water, the duration of the “wetting” (diffusion of the water on the ingredient, favoring the expansion of the panel in the enveloping chamber), the time of contact between the water flow and the particles for absorbing the aromas and soluble substances, the consistency and distribution of the water flow on the panel, the adherence of the ingredient to the inner wall of the panel, the water temperature and presence of CO2 to form the froth.

All these variables influence the pressurization of the panel which, in turn, determines the quality of the beverage obtained.

The cylindrical shape is the most commonly used geometry for the porous panels for extracting or solubilizing beverages. This is because it allows a constant and controlled passage of the water through the porous panel, regardless of the position with respect to the central axis of the flow, as long as the panel has a uniform porosity, uniform distribution of the water and a constant flow in conditions of static pressurization.

In the most common systems for preparing beverages by means of pressurized extraction with hot or cold water, which usually use volumetric piston pumps, it is difficult to obtain a constant flow, static pressure and a uniform distribution of the water on the porous panel. This leads to a more concentrated flow in the center, to the detriment of the peripheral zones of the panel, which are not optimally extracted. Moreover, this lack of uniformity in percolation can increase the risk of the formation of preferential paths in the central zone and the reduction of substances, especially if the porous panel is already damaged as a result of transport or handling prior to use.

The spherical shape with truncated poles centrally offers a longer and more tortuous path through the panel, which gradually grows shorter, moving away from the central axis of the flow. This means that the water penetrating the peripheral zones meets less hydraulic resistance, thus balancing the Gaussian distribution thereof and allowing a more efficient extraction, also of the ingredient in the peripheral areas. By virtue of the spherical shape with truncated poles:
the water, or nonetheless the extraction fluid is well-distributed and further penetrates the entire hemisphere;
the porous panel adheres correctly to the outer wall during the expansion;
the extract can easily flow towards the central or decentered outlet area with respect to the central axis.

In brief, a spherical shape with truncated poles containing a porous ingredient with uniform permeability, during percolation, can ensure a highly efficient percolation as it reduces the central flow amount and favors a more even distribution, further also wetting the peripheral zones.

By virtue of the spherical shape and truncated poles, the flow initially moves away (meeting the ingredient to be percolated), but then it moves closer again at the end, where the ingredient is denser and more compressed (and more occluded).

This means that the flow starts to slow down when it meets the ingredient, but then it speeds up again in the outlet zone where the ingredient is denser and more compressed.

This effect on the flow is given by the transverse diameter of the path, which is equivalent to the volume of the conduit available to the flow. It can be understood considering the cross-section of the flow through the porous body.

The slowing down and speeding up effect of the flow is used in many systems, such as hydraulic systems, ejectors, sprinklers and venturi valves, for example. Also in coffee percolation, this effect can be used to the advantage of the quality of the percolation.

The cross-section, which gradually widens, favors the distribution of the water on the inlet surface, without needing to create interstices for the diffusion. On the other hand, a cross-section, which gradually narrows, further compacts the granules in the lower zone, being pushed by the hydraulic pressure at the top. This compaction is then supported by the surrounding extraction chamber, providing the necessary contrast.

Observing transversely, the lower layers of the porous panel, as a result of the reduced resistive thickness thereof, also offer less hydraulic resistance than the overlying ones, which means that as the water gradually passes through the porous panel, it meets less and less resistance, thus decreasing the pressure. In order to also extract efficiently the lower layers of the panel, the wedge effect contrasts this reduced resistance, compacting the granules with the aid of the migration of the fine granules towards the outlet, making the flow path more tortuous and contrasting the acceleration of the flow, due to the narrowing of the cross-section.

The automatic wedge-effect compaction of the lower hemisphere provides greater resistance to the lower levels, also allowing maximum utilization of these levels of the ingredient. Moreover, there is a potential “self-repair” effect of possible preferential paths caused by breakages of the panel or the migration of particles. In practice, the automatic compaction takes place during percolation subjected to pressure.

Those skilled in the art know that the movement of fine powders or granules during packaging, transport and handling can negatively affect the quality of the percolation of the beverage. These smaller and lighter particles tend to move more easily, creating a lack of uniformity in the distribution of the granule mixture. This can result in problems, such as the obstruction of filters or narrow passageways by the fine granules, causing an increase in hydraulic pressure and a decrease in the percolation flow. However, the presence of fine granules is also very important to obtain a good quality percolation and correct froth formation. Therefore, it is essential to find the right balance between the presence of fine granules and the capacity thereof to cause problems, ensuring that they are adequately supported and locked in the mesh made of the larger granules/particles than the granulate compressed in the package and that it is supported without collapsing in the extraction chamber. If the fine granules move around too much, the extraction pressure can increase too much, causing a decline in the flow. This can result in an over-extraction. The spherical shape with the compressed ingredient contributes to blocking these fine granules in high zones of the porous panel.

The shape of two hemispheres with truncated poles is perfect for being easily deep drawn, especially with even very thin laminated materials, such as metal ones, e.g., with aluminum layers, offering complete protection from oxygen and humidity. The geometry with the ratio depth/diameter smaller than 0.5 and the progressive shape also lends itself well to formation with other materials, such as semi-finished products or cellulose-based multi-layers, paper, polymers, metals or combinations of these. This shape is ideal for preserving foodstuffs sensitive to deterioration, such as coffee, ensuring a longer duration (less waste due to expiry or deterioration and minimum surface contact towards the outside).

The hemispherical shape with truncated poles is suitable for deep drawing since it has an optimal ratio of depth of the cavity with respect to the diameter, and the progressive shape thereof makes the deep drawing less critical with ultrathin materials. Moreover, this shape lends itself to being made with more rigid alloys containing a higher percentage of recycled materials, for a more sustainable context and technological efficiency.

The spherical shape with the truncated poles is adapted to be easily expelled from an extraction chamber of a machine with a similar shape, but separate on the symmetrical central plane. This allows loading and unloading of the capsule, maintaining a profile closer to the adjacent spherical shape. The progressive spherical shape also facilitates the expulsion with expulsion angles greater than 6 degrees.

The spherical shape with truncated poles can be inserted in both directions (inverting the N-S or S-N polarity) into the extraction system, and this will not influence the final result of the beverage extracted. This means that the user does not need to worry about how to insert the capsule into the machine.

According to an alternative embodiment, the spherical shape with truncated poles allows possibly obtaining a different extraction result based on the direction of insertion with respect to the symmetrical plane thereof. This means that the user could obtain different beverages simply by positioning the capsule differently in the machine. This ability to differentiate the result without having to make changes to the user interface of the machine is a key advantage of the spherical shape with truncated poles with the plane of symmetry midway of the capsule.

The spherical shape with truncated poles is a simple shape which is easily recognizable, archetypal, iconic and symbolic, with a historic correlation with the concept of Easy Serving Espresso, which then became a common widespread standard.

The truncated portion can be made in a slightly concave manner to provide support for the coffee with a “spring effect” or even to allow the gases to come out from the coffee inside the package. This is only one example of possible performance variants.

Hereinafter, the terms “half-capsules” or “half-shells” will be used as mutually interchangeable.

By virtue of the capsule according to further constructional variants in which the capsule consists of two identical half-shells, or half-capsules, placed facing each other and mutually specular, it is possible to obtain a symmetry of the capsule with respect to a symmetry plane and thus greater simplicity of use for users.

By virtue of these features, the production process for making the capsule casing is simplified, for example by allowing the use of only one mold and/or only one production process for both half-shells above & below, with lower costs, less logistics, reduced waste, etc.

The capsules consisting of two specular half-capsules, or half-shells, have a uniform barrier effect to oxygen and humidity along the entire periphery. There is no weak zone prone to inhomogeneities in thickness, porosity from micro-holes or thin walls, unlike the capsules of the truncated-cone type having a film acting as a thin cover for functional needs. In the case of a spherical shape with truncated poles, the risk of spillages and degassing in adverse conditions (such as internal CO2/N2 pressure or low external pressure during air transport) is minimum, without swellings or leaks through micro-porosity or faulty zones. This contributes to maintaining an extended shelf life, reducing waste and rejects, improving the perceived reliability and quality.

The specular outline allows a visual identification and intuitive reading of the possible user both symmetrically and inverted.

By virtue of a capsule shape with truncated poles, which are flat in one embodiment, it is possible to have several advantages.

The spherical shape with truncated poles allows stably positioning the capsules flat on a support surface, preventing them from rolling. This feature is useful during production, transport, packaging, handling, opening of the package and practical use, improving the presentation to users.

The spherical shape with truncated poles of the capsules allows neatly stacking the capsules and saving space, e.g., in a secondary package. This contributes to optimizing the use of the spaces, reducing weight, material and gaps, preserving the integrity of the capsules from possible external knocks or falls.

The flattened shape of the truncated poles of the capsule makes the piercing process easier and more controlled using a piercer, or a piercing device for injecting fluid into the capsule, which transversely enters the plane of the truncated pole. This allows applying a pressure perpendicular, or almost perpendicular to the wall, which must be pierced, thus improving easy opening.

By virtue of the piercing of the capsule in one of the truncated poles thereof, the capsule has a small central inlet and outlet opening, reducing contact with the extraction chamber. Few contact residues (low level of cross-contamination), and less influence of the temperature in the chamber during percolation (first or second consecutive beverage extraction). The cross-contamination effect is particularly felt with ingredients, which leave a clear organoleptic mark (e.g., ginseng or barley) or which are highly subject to deterioration as a result of oxidation, such as rancid coffee. In particular, in the outlet zone, it is convenient to limit contact with the system for containing and conveying the flow towards the outside. Thus, ideally, a minimum contact with the machine at the outlet is desired.

According to an embodiment, the capsule is pierced at the inlet by means of a central piercer, which can include one or more knives, tubes or cannulas, which can rotate about a central axis in the direction of the flow.

During the extraction of the beverage, a piercer, or opening device for the extract to come out from the capsule, tears the flat outlet zone of the capsule, i.e., a truncated pole, which deforms outwards under pressure. This piercer is a fixed part of the extraction chamber and is positioned resting on the capsule, but, according to an embodiment, without piercing it in the closing step of the chamber. During the extraction, the flat zone of the truncated pole of the capsule around the piercer is not supported and therefore collapses downwards against the sharp edges of the piercer, thus creating openings in the outer wall of the capsule, which is subject to hydraulic pressure. The filter inside the capsule dilates, but it does not break by virtue of the greater deformability thereof and the specific shape of the piercer.

The filter preserves the capacity thereof to retain the solid particulates, while it lets the extract pass through the formed opening. Only the head of the piercer is sharp and not very deep, limiting uncontrolled breakage of the outer wall to a few holes caused by the tearing, and ensuring adequate support for the external hydraulic stresses.

The geometry and performance of the piercer can be different, however, it is preferable to use simple piercers, which create few openings in the outer wall, preferably by means of shear and not traction stress, providing adequate support for the overlying filter and ensuring reliable passageways for the outcoming flow.

According to an embodiment, for example for beverages in which it is undesirable to create excessive pressure during the extraction, e.g., for an American coffee or a coffee of the “drip” type, where the froth is not desired, the spherical capsule with truncated poles has a greater dimension with the flat zones being further from the capsule center, but maintaining the same spherical capsule diameter. This allows piercing the outlet of the capsule on closing the chamber before the extraction step, for greater overlapping between the truncated poles and the inlet and outlet piercers.

In order to avoid creating excessive pressure during the extraction of the beverage, alternatively, it is possible to weak the capsule wall in one or both truncated poles, so as to reduce the pressure needed to tear it. This method allows using a single piercer and a single capsule size, thus simplifying the production process.

The flat truncated part of the capsule is that with the thinnest thickness after deep drawing, which can be further weakened with a logo or another element. This weak area is used for tearing and introducing water in a controlled manner and causing the extract to come out from the capsule. Customization with the relief logo, obtained by means of local embossing, can be modified according to the depth with which the dowel-punch penetrates. The greater the depth, the more easily the capsule will open, minimizing the pressure needed for opening. Moreover, the final passage for the extract must not cause further resistance for minimizing the formation of froth, using a unique geometry for the piercer.

By virtue of the capsule according to further constructional variants in which the capsule comprises an annular flange in the equatorial zone, e.g., with a planar contact zone (head) for joining the facing half-capsules, it is possible to obtain a thermal pressure sealing between the two half-capsules, or half-shells, consolidating a solid joint, which is hermetic and capable of withstanding mechanical stresses during the steps of handling, as well as the difference in internal/external pressure in various circumstances of packaging, storage, transport and handling before use.

The planar face-to-face sealing by heat-sealing, for example, is the preferred and tested solution for bulk production. However, the possibility is not excluded of using other joining technologies, such as ultrasound/induction sealing, gluing with wax/adhesive agents or crimping by adhesion sealing. This flexibility does not result in great effects on the support systems or the extraction chambers of the machine. Therefore, it is a reliable and flexible solution in terms of the development and production, which is compatible with other shapes and materials to be applied in the evolved future.

The flange, as defined, protrudes, and is an important element for handling the capsules, which helps avoid contact with the zones intended to come into contact with the liquids of the beverage (for reasons of hygiene). Moreover, being easier to grasp, it helps avoid excessive compression of the spherical zone, contributing to the reliability of the percolation process and the correct working of the capsule during the dispensing.

The flange provides a reinforcement element, dimensional stability and easy handling during the production and assembly of the capsules.

According to a general embodiment, a capsule for preparing a predetermined amount of beverage suitable for consumption, using an extractable product, e.g., ground coffee, comprises a first and a second half-capsule. Each half-capsule comprises a thin capsule wall. Said thin capsule wall forms in one piece a first thin wall portion delimiting a substantially hemispherical inner half-chamber. Said capsule wall, close to the greater dimension thereof forms, in one piece with said first thin wall portion, a second thin wall portion which bends to form an annular flange. Said two half-capsules are arranged facing each other and mutually specular and they are joined to each other. At least one of said annular flanges of said half-capsules comprises a free flange end edge, which forms a flange ring, where said flange ring comprises an overall ring thickness h1 greater than the thickness h2 of said portion of said annular flange (in the figures, with extension indicated by L) placed in contact with the adjacent half-capsule.

By virtue of the embodiment including a flange ring, e.g., a curl, it is possible to obtain several advantages, e.g., the following advantages. The outer curl serves, for example, to keep a suitable distance between the capsules to prevent them from sticking together when they are stacked on top of one another (spacer for stacking) and facilitate transport and temporary storage (orderly stacking is convenient for an efficient use of the space/package before production of the half-capsules) and allows efficient industrial handling, with different robotic positionings and transfers at the time of production. The outer protruding edge is useful for preventing attachments or rubbing when stacking the capsules and serves as a spacer for facilitating a controlled detachment. Moreover, it provides a mechanical support for positioning the half-capsules on the conveyor belt by means of convenient holes or seats, and allowing the assembled capsules to be grasped during the packaging operation without touching or crushing the spherical part.

For the deep drawing technique, which is the most suitable solution for single-dose capsules made with sheets or ultrathin multi-layers of metal, the flange is an element, which becomes highly useful. The curl placed at the free end of the flange also allows concealing the irregularity or wavy edge, resulting from the deep drawing.

The equatorial flange is important for understanding how to insert the capsule into a seat or support with a corresponding shape. Moreover, it provides the possibility of distinguishing between the different types of capsules, without having to create multiple capsule shapes or outlines, or multiplying the number of production, assembly or packaging lines. This has a strong impact on investments in the necessary industrial tools and the development times.

The flange further provides a flat surface adapted to create a sealing with, for example, an elastic component in the extraction chamber.

The planar surface of the flange, in contact between the two facing half-capsules, is adapted to be pressed or pinched by a rigid support, part of the extraction chamber, on the seal of the facing flanges, preferably a joint between two layers of varnish adhering to the metal sheet or also cellulose-based paper, during the pressurization of the inside contents. Independently of the fact that the hydraulic pressure acts only inside the capsule or also outside in the space between the casing and the cavity of the receiving extraction chamber, this rigid support is critical for ensuring desired levels of pressure during extraction, usually in the range of 0-22 bars and preferably in the range of 7-18 bars. This optimal target pressure on the coffee panel ensures a quality extraction with a good character balance and plenty of froth. Obviously, a wider flange (joint) provides a more solid mechanical support, thus reinforcing the resistance against the opening, favoring the hermetic seal and preventing the loss or complete separation of the joint between the half-capsules.

The hydraulic pressure and the forces produced by the dilation of the panel of granules/ground material compressed inside the capsule can cause significant stresses towards the unit supporting it. These stresses cannot be supported by the mechanical resistance of the thin wall of the capsule alone or by the joint thereof (crimping, thermo-pressing, sealing, adhesion or other). Therefore, the flange provides an additional support zone, leaving the extraction chamber openable on the symmetrical plane for successively allowing the expulsion thereof.

The edge of the capsule can be used as a point of reference for expulsion from the extraction chamber, e.g., using a compression, Belleville, or wave spring, or even a flexible element, such as a lip seal, which, by compression, seals and, in the open state, opens and pushes against the edge of the capsule for the expulsion thereof from the machine.

For capsules with predetermined inlet and outlet (or where the inlet and the outlet cannot be random), precise positioning is necessary. The flange or joint edge provides a visual/perceptive reference and also a grip for positioning the capsule in a defined manner, preventing the spherical part from being crushed.

The edge acts as a control and guide element for controlled and directional movements in semi-automatic units, in both units with horizontal closing axis and those with vertical closing axis.

The edge of the capsule prevents the capsule from rolling over long distances. If it is positioned on a protruding edge touching a surface, it can only move circularly on a limited radius, avoiding moving away from the original position. This feature can be useful in many situations, preventing the capsule from falling from surfaces, such as a work surface or a kitchen.

The flange, or edge of the capsule, can or cannot include a flange ring or curls. The flange ring serves as a useful element for an ordered fastening inside a secondary package, such as a box, for example. Moreover, it offers a grip for extracting the capsule from the package. For randomly packed capsules, it can provide a spacing function for protection against damage and dents during the transport step.

The annular flange is a useful element for opening the capsule after use, providing a supporting edge for picking it up and handling it easily (especially if it is still hot). Moreover, the annular shape of the flange makes it easier to empty the capsule with respect to cylindrical shapes because of the progressive draft angle thereof, allowing a controlled separation of the used ingredient from the capsule. If a special instrument is used to empty the capsule after use and separate the package from the used product, the outer edge can be used as a support point.

The presence of a joining flange allows a sealing between the facing flanges of the half-capsules, which ensures a long shelf-life, withstanding internal pressure caused by the degassing and strong enough to withstand external depression during air transport. The flange allows only a partial mechanical support in the dispensing step, which is limited only to the outer circumference so that the dispensing helps open about half of the sealing for dilating the pressurized ingredient. After use, the capsule can be opened and separated more easily because of the reduced resistance of the joint, which is now partially open because of the pressure load during the dispensing.

The edge or flange of the capsule offer a visible surface on both sides for identifying the type of ingredient inside. This surface is quite large, allowing additional information to be inserted, such as text (e.g., sku, family), icon, pictograms or symbols (e.g., material group code, recycling code), numbers or dates (e.g., date of production or expiry), for helping in the identification or for indicating how to open, dispose of or use the capsule after use. This information can also be present on the cap or on the upper plane of the truncated pole, even if the space available is limited for the philosophy of minimizing the weight of the capsule for reasons of sustainability and costs.

The flange could be colored for identifying the type of ingredient or the type of preparation. This identification could be carried out by means of an electronic reading system present in the extraction machine or apparatus preparing the product. The reading system could recognize the color from both the zone of the flange and the zone of the cap or upper surface. This would make the preparation process automatic, without requiring any input from the user.

By virtue of the capsule of the invention, and in particular by virtue of the provision of at least one flange ring, e.g., a curl, it is possible to obtain the following advantages.

The at least one curl or curls on the edge of the flange of the capsule is/are obtained from sheets of aluminum, for example. For example, directly in the deep drawing step of the half-capsule due to the shape of the die. These curls are useful for concealing the inevitable irregularity (wave) resulting from the deep drawing process and thus serves to uniform the edge of the flange and thus of the capsule. Moreover, these curls provide mechanical resistance and prevent the formation of sharp and easily deformable edges.

The flange ring, for example, the curls, on the edges of the capsules, allow distinguishing the different capsule versions, e.g., Home from the Professional one, maintaining the possibility of filling both capsules on the same production line and with the same dose and compaction. The differentiation is made by arranging the curls (e.g., specularly overlapping for the Home version, one next to the other for the Professional version), while maintaining the same joining width and zone as the flat flange segment (heat-sealing-pressing, adhesion by gluing, crimping or a combination thereof).

The curls on the edge of the capsule serve to keep a certain distance between the half-capsules or half-shells, allowing them to be stacked close to one another without them sticking together. This allows a robotic handling during the assembly and filling step, preventing the surface from rubbing and reducing the direct contact between the half-capsules or half-shells.

By virtue of the provision of at least one filter, it is possible to obtain the following advantages.

The filter, according to a possible embodiment of the present invention, is disc-shaped, obtained by cutting or punching from a reel or sheet of recyclable or compostable material, at both industrial and household level, with a greater diameter than the diameter of the capsule zone of the truncated pole.

The filter material, e.g., materials, which are spun laid non-wovens/thermo-bonded spun wovens/non wovens, filter paper, cellulose, laminates or melt blown needle-punched filter fabrics, has, according to an embodiment, but not necessarily, a sealing layer so as to allow the fastening thereof to the inner zone of the half-capsule or capsule half-shell, in particular the concave wall close to the truncated pole segment.

According to an embodiment, the filter is sealed to the concave surface of the half-shell which is for example made of metal, for example of aluminum, by means of heat-sealing onto the maximum circumference of the filter disc. According to an embodiment, even if the greater peripheral surface of the filter is adapted to the shape of the cap, it creates lateral folds, which can form umbrella-shaped channels. According to an embodiment, for the greater peripheral surface, although the filter lies in the outline of the cap, it forms lateral plissés, which can create umbrella channels. In the injection zone of the water these channels with micro-passageways, create a shower effect, suitably spreading the water at the central inlet over the entire porous panel or over the non-compacted dissolved solubles. Whereas, in the outlet half-shell or half-capsule these channels are crushed and favor a partial lifting of the filter from the inner surface of the shell, favoring the exit of the dispensed beverage.

By virtue of the suggested embodiments, the filter partially limits the desired and allowed dilation of the porous panel of the ingredient to be extracted in the wetting/percolation step, thus avoiding the bypass effect or the flow around the porous panel, favoring the quick and complete wetting over the entire porous hemisphere.

By virtue of the suggested embodiments, the same filter, which is also intact at the end of dispensing, can prevent the suction/migration of solid particle ingredients or ingredients dissolved in the circuit upstream of the capsule inlet, potentially occluding, blocking passageways, dirtying/gluing movable parts, e.g., the center of solenoid valves, and forming scale with residues and fats or sugars, which can stain/perceptibly alter the taste of successive extractions or percolations, or block, or even reversibly/irreversibly damage the system.

By virtue of the suggested embodiments, the filter in the coffee outlet half-shell prevents solid particles or non-dissolved ingredients in the circuit downstream of the capsule from coming out/migrating, which could occlude, block passageways, and also reversibly/irreversibly block or damage the system.

The percolation dynamics obtainable with any of the embodiments described above or below will be described hereafter.

According to an embodiment, the piercing and coffee exit during extraction is obtained. The method for preparing the coffee beverage, using the aforesaid capsule containing ground roasted coffee, consists in inserting the capsule into the extraction unit, also referred to as an extraction apparatus or an extraction machine or simply machine. This consists of a housing for the capsule and piercing elements for the entry of the water (water injection or piercing device for injecting fluid into the capsule) and the coffee outlet (or opening device for the extract to come out from the capsule). The shape of the housing is shaped to accommodate and support the entire surface of the capsule except for the truncated poles, which are not supported by the shape of the chamber, but which can deform in a concave or convex manner under pressure. The piercing elements are positioned in the areas of the extraction unit facing the truncated poles of the capsule.

According to an embodiment, the opening of the water inlet zone occurs by means of a piercing caused by the closing of the chamber. The piercing elements remain inside the capsule during the entire extraction, penetrating the capsule.

According to an embodiment, pressurized, hot water is injected through the capsule piercing elements so that the water flows mainly inside the capsule and is conveyed to a specific zone between the aluminum shell and the filter positioned in the upper part of the capsule, in a zone limited to only the truncated pole.

The filter promotes and facilitates the quick and complete wetting over the entire porous surface, also reaching the peripheral zones (wetting).

According to an embodiment, the dynamic of the percolation is based on the method where the inner hydraulic pressure opens the capsule (ballooning against an integral piercer element). Since the capsule is initially closed in the coffee outlet zone, the water spreads across the porous coffee panel also in the peripheral zones, creating a highly effective impregnation/wetting, due to the extended diffusion of the water and the repairing of any splits in the porous panel caused by external impacts. Moreover, this process causes the anticipated formation of froth, by virtue of the dilation of the ingredient and the absorption of aromatic gases, mainly CO2.

This process takes place through the opening of the capsule during the extraction against a central piercer body or opening device for the extract to come out from the capsule. The pressure inside the capsule, which reaches an elevated level (between 5 and 12 bars) following the introduction of water, causes the outer capsule wall to deform and dilate in the zone of the truncated pole positioned at the outlet due to a lack of support from the wall by the extraction chamber.

This dilation is controlled through a proportioned piercer body, which causes a partial breakage and controlled opening of the capsule. This allows the coffee to come out after wetting.

According to an embodiment, the piercer element has openings, channels or passageways, which allow the extract to pass through. This piercer element does not filter the contents of the capsule, but only serves the function of opening the outer barrier wall of the capsule in a controlled manner, avoiding excessive tearing and supporting the application and deformation of the filter and the ingredients. The piercer support allows the capsule to avoid the collapse thereof together with the inner filter and the ingredients.

According to an embodiment, there are provided inner filters fixed in the upper and lower half-shells, close to the truncated poles. The filter positioned on the upper half-shell prevents the particulate from rising/being sucked up into the water injection zone, while the filter positioned on the lower half-shell prevents the ground coffee from coming out into the cup.

According to an embodiment, the coffee flow depends on the granulometry of the ground coffee contained in the capsule and, in particular, on the percentage of fine granules. Other factors affecting the flow include dose, temperature, wetting, pump, freshness, resistance of the porous panel, filter and passageways.

According to an embodiment, the coffee outlet piercing takes place when the extraction unit or extraction apparatus is being closed. By changing the shape of the capsule, such as the spherical geometry thereof, or by only increasing the height of the half-shells, or as described previously, by reducing the pressure needed for the opening against an outer piercer body, it is possible to obtain a simultaneous piercing of both the inlet and the outlet during the closing of the extraction chamber. This opening method is preferable to avoid or limit the formation of froth as with preparing American coffee (drip) or tea in leaves or for the dissolution of soluble ingredients, such as coffee, barley, ginseng, tea, cocoa or milk.

In this situation, despite being a fixed part of the chamber, the piercing elements interfere more with the capsule, seen overlapping with the outer outline of the capsule. Thus, the piercing elements are better capable of penetrating the capsule, creating the opening right at the start of the extraction and allowing smaller initial pressure peaks and a wider beverage flow exiting the capsule.

### BRIEF DESCRIPTION OF THE DRAWINGS

Further features and advantages of the invention will become apparent from the description provided below of preferred embodiments thereof, given by way of non-limiting indication, with reference to the accompanying drawings, in which:

FIG. 1 shows an axonometric view of a capsule according to a first embodiment in which the flange rings are arranged overlapping according to a direction orthogonal to the median capsule plane;

FIG. 2 shows an axonometric view of the capsule in FIG. 1 with separate parts, highlighting the two half-capsules, the two filters positioned close to the truncated poles, but without showing the extractable product panel;

FIG. 3 shows an axonometric view of the capsule in FIG. 1, with separate parts and sectioned according to a plane passing through the radial direction R-R and the center of the two opposite truncated poles;

FIG. 4 shows a sectional view of the capsule in FIG. 3 with separate parts;

FIG. 5 is an axonometric sectional view of a detail of the flange of a half-capsule in FIG. 3;

FIG. 6 shows a side view of a detail of the flanges of the two coupled half-capsules of the capsule in FIG. 1;

FIG. 7 shows a radial sectional view of the detail of FIG. 6;

FIGS. 8 and 9 show a side and radial sectional view of the detail of FIG. 6;

FIGS. 10 and 11 show a sectional view of a detail of a truncated pole and a detail of the truncated pole in FIG. 10 highlighting the filter and the coupling thereof to the concave wall of the half-capsule;

FIGS. 12, 13 and 14 show five half-capsules, according to a first embodiment in which the flange ring extends into the same half-space in which the first thin wall portion with a truncated cap extends, where the half-capsules are stacked and where there is highlighted a further role of the flange ring, here in the shape of a curl, for spacing apart each half-capsule from the adjacent one;

FIG. 15 shows an axonometric view of a user's hand gripping a capsule with his/her thumb and with his/her index finger gripping the truncated poles of a capsule, a capsule stably resting on a plane with one of the truncated poles thereof and, in the case of a knock, a capsule rolling on the plane against the flange, and also a half-capsule stably resting on a plane with one of the truncated poles thereof and, in the case of a knock, rolling on the plane against the flange thereof;

FIGS. 17, 18, 19 and 20 show a view of a first capsule with the flanges having flange rings overlapping along a direction orthogonal to the median capsule plane, as well as a detail of a radial section of said flange rings, and a second capsule with flange rings radially placed side-by-side, as well as a radial section of a detail of said flange rings;

FIGS. 21, 22 and 23 show five half-capsules, according to a second embodiment in which the flange ring extends into the half-space opposite to the half-space in which the first thin wall portion with a truncated cap extends, where the half-capsules are stacked and where there is highlighted a further role of the flange ring, here in the shape of a curl, for spacing apart each half-capsule from the adjacent one;

FIG. 24 shows an axonometric view of a capsule according to a further embodiment in which the flange rings are arranged radially side-by-side;

FIG. 25 shows an axonometric view of the capsule in FIG. 24 with separate parts, highlighting the two half-capsules, the two filters positioned close to the truncated poles, but without showing the extractable product panel;

FIG. 26 shows an axonometric view of the capsule in FIG. 24, with separate parts and sectioned according to a plane passing through the radial direction R-R and the center of the two opposite truncated poles;

FIG. 27 shows a sectional view of the capsule in FIG. 26 with separate parts;

FIG. 28 shows an axonometric sectional view of a detail of the flange of a half-capsule in FIG. 24;

FIG. 29 shows a side view of a detail of the section of the flanges of the two coupled half-capsules of the capsule in FIG. 24;

FIG. 30 shows a radial sectional view of the detail of FIG. 29;

FIGS. 31 to 34 show an axonometric view, a side view and radial sectional view of a capsule according to a further embodiment in which the thin wall has a truncated polyhedral sphere shape;

FIGS. 35 and 36 show an axonometric view of a capsule according to a further embodiment in which the thin wall has a spherical shape with grooves;

FIGS. 37 to 40 show an axonometric view, an axonometric view sectioned according to a radial plane, a section view and a detail of the flanges of a capsule according to a further embodiment in which the flanges do not have a flange ring;

FIGS. 41, 42 to 43 show an axonometric view, and axonometric view sectioned according to a radial plane and a detail of the coupled flanges of a capsule according to a further embodiment in which the flange ring has a specularly arranged annular channel shape;

FIGS. 44 and 45 show a sectional view and a view with a detail of said section of a capsule according to a further embodiment in which the spherical capsule with truncated poles has flanges without flange ring, and with a different radial extension;

FIGS. 46, 47, 48 and 49 show an axonometric view, an axonometric view sectioned according to a radial plane, a section view and a detail of the coupled flanges of a capsule according to a further embodiment in which the flange ring has an annular channel shape where the two channels are arranged radially side-by-side;

FIGS. 50, 51 and 52 show a radial sectional axonometric view and an axonometric view sectioned according to a radial plane of a further embodiment of the capsule, in which the first part of the thin wall of each half-capsule is shaped like a spherical half-cap and in this case no truncated poles are present; according to this embodiment, the flange rings are mutually overlapping along a direction transversal to the median plane;

FIGS. 53, 54 and 55 show a radial sectional axonometric view and an axonometric view sectioned according to a radial plane of a further embodiment of the capsule, in which the first part of the thin wall of each half-capsule is shaped like a spherical half-cap and in this case no truncated poles are present; according to this embodiment, the flange rings are radially placed side-by-side;

FIG. 56 shows a sectional view of an open extraction apparatus of a machine in which a capsule is interposed;

FIG. 57 shows a sectional view of the extraction apparatus in FIG. 56 closed on a capsule;

FIG. 58 shows a sectional view of a detail of the extraction apparatus in FIG. 57 highlighting the interaction of the opening device for the extract to come out from the capsule with the truncated pole intended for opening for the extract to come out, and in which the integrity of the filter is highlighted;

FIGS. 59, 60, 61, 62 show a sectional view of an open extraction apparatus, in which a capsule is interposed; the extraction apparatus in FIG. 59 closed on a capsule; a detail of the extraction apparatus in FIG. 59 highlighting the seat for the flange rings arranged overlapping according to a direction orthogonal to a median capsule plane; as well as an overlapping on the same seat of two flanges having the flange rings radially placed side-by-side, highlighting the impossibility of housing these rings in this seat, so as to prevent the insertion into the extraction apparatus of types of capsules not intended for the extraction apparatus having this specific seat for the overlapping flange rings;

FIGS. 63, 64, 65, 66 show a sectional view of an open extraction apparatus in which a capsule is interposed; the extraction apparatus in FIG. 63 closed on a capsule; a detail of the extraction apparatus in FIG. 63 highlighting the seat for the flange rings arranged radially side-by-side; and an overlapping on the same seat of two flanges having the flange rings overlapping along a direction orthogonal to the median capsule plane, highlighting the impossibility of housing these rings in this seat, so as to prevent the insertion into the extraction apparatus of types of capsules not intended for the extraction apparatus having this specific seat for the overlapping flange rings; and also a seat for the flange rings arranged radially side-by-side which is adapted to receive capsules with inverted polarity;

FIGS. 67, 68, 69, 70, 71 show a sectional view of an extraction apparatus closed on a capsule; a detail of the piercing device for injecting fluid into the capsule piercing the thin wall, but not the filter at the inlet when the extraction apparatus is closed; and three steps of deforming the truncated pole intended for opening the capsule for the extract to come out, in which the thin wall of the truncated pole does not open when the extraction apparatus is being closed, but deforms with the increase in pressure of the fluid introduced into the capsule until being cut on the opening device for the extract to come out from the capsule creating exit openings, without breaking the filter arranged close thereto, which is deformed without being cut;

FIGS. 72 and 73 show an axonometric view and a side view of six steps of the production process, where the first step shows the strip punching of a thin wall disc, the second step shows the deep drawing of the lower half-capsule with a punch and a mold, the third step shows the filling with extractable product, the fourth step shows the compaction of the extractable product into a spherical extractable product panel, the fifth step shows the specular coupling of an upper half-capsule, the sixth step shows the heat-sealing of the upper flange onto the lower flange;

FIG. 74 shows an axonometric view, with separate parts, of a used capsule emptying device for separating the used extractable product from the thin capsule wall, in which a collection chamber, a used capsule, and a cover accommodating a piston are shown with separate parts;

FIG. 75 shows a longitudinal sectional view of the device and the used capsule in FIG. 74;

FIGS. 76 to 78 show a longitudinal sectional view of three steps of emptying the used capsule, where FIG. 76 shows the capsule resting with the annular flange of the lower half-capsule thereof on the edge of the collection chamber, where a seat accommodates the lower half-capsule flange ring, then the cover is fitted outside the collection chamber and with an inner edge thereof locks the annular flange of upper half-capsule and receiving the flange ring of the upper half-capsule in an opposite seat, and where the piston slides telescopically in the seat thereof provided in the cover until it rests on the upper pole of the upper half-capsule; FIG. 77 shows the piston which has completed the telescopic travel thereof completely entering the cover and crushing the used capsule which, by virtue of the openings made therein by the opening device for the extract to come out from the capsule, tears the thin capsule wall, allowing the extractable product to come out as the capsule is gradually crushed; FIG. 78 shows the opening of the emptying device and the extraction of the thin capsule wall emptied of the extractable product, which is collected at the bottom of the collection chamber;

FIG. 79 shows an axonometric view of the assembly in FIG. 78;

FIGS. 80, 81 and 82 show an axonometric view, a side view and a sectional view of a capsule in which the half-capsules have a first thin wall portion with a cylindrical wall segment and a spherical cap wall segment with a truncated pole, where this entire first thin wall portion is circumscribed in an outer hemisphere and inscribed by an inner hemisphere, where the difference in diameter between the two hemispheres is less than 10%;

FIGS. 83 and 84 show an axonometric view, a side view and a sectional view of a capsule in which the half-capsules have a first thin wall portion with a cylindrical wall segment and a spherical cap wall segment without truncated pole, where this entire first thin wall portion is inscribed in an outer hemisphere and circumscribed in an inner hemisphere, where the difference in diameter between the two hemispheres is less than 10%.

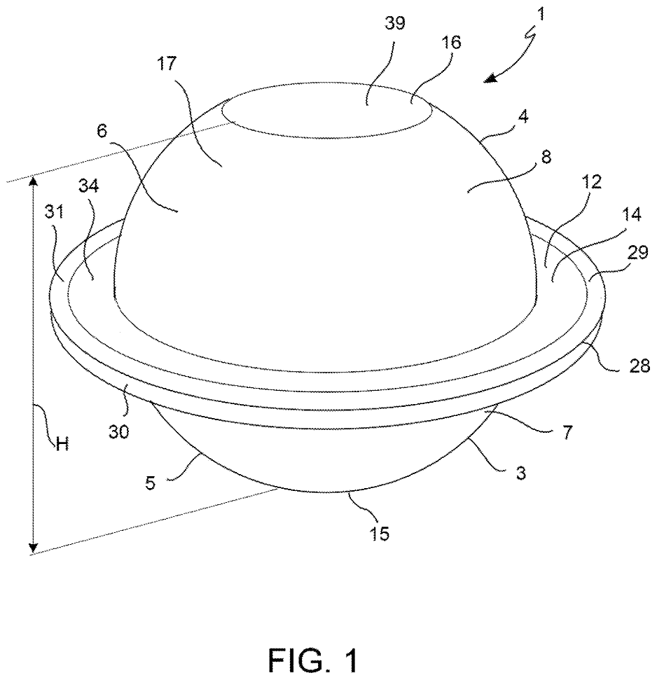

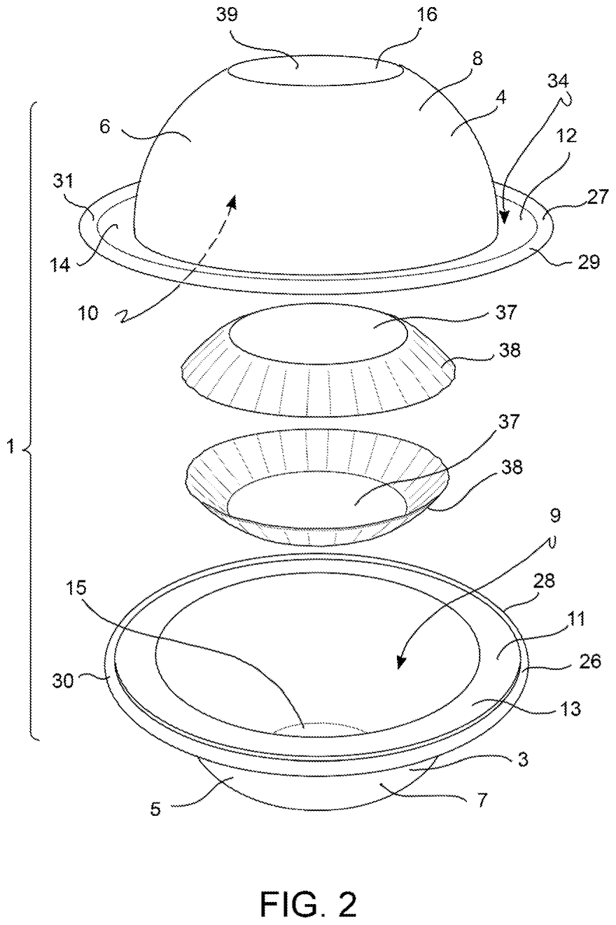

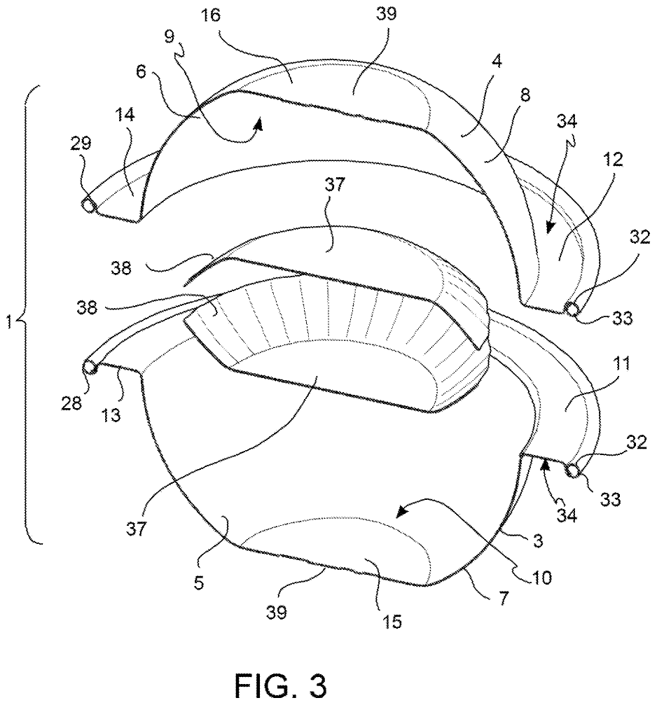

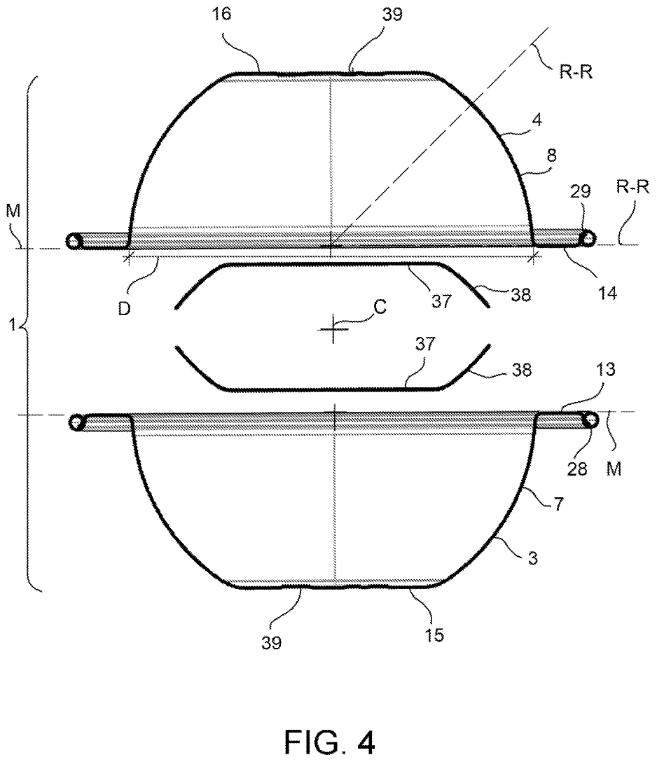

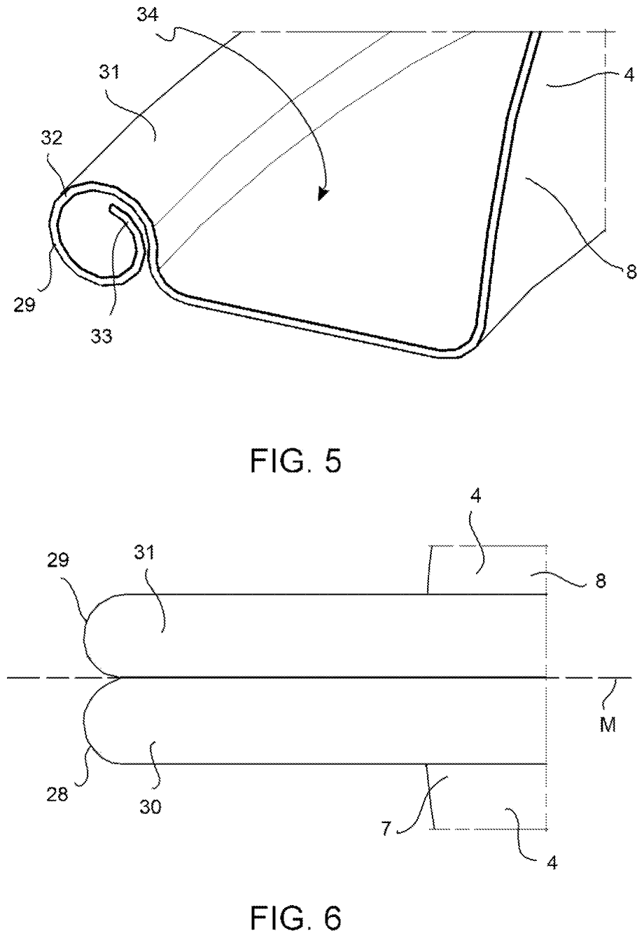

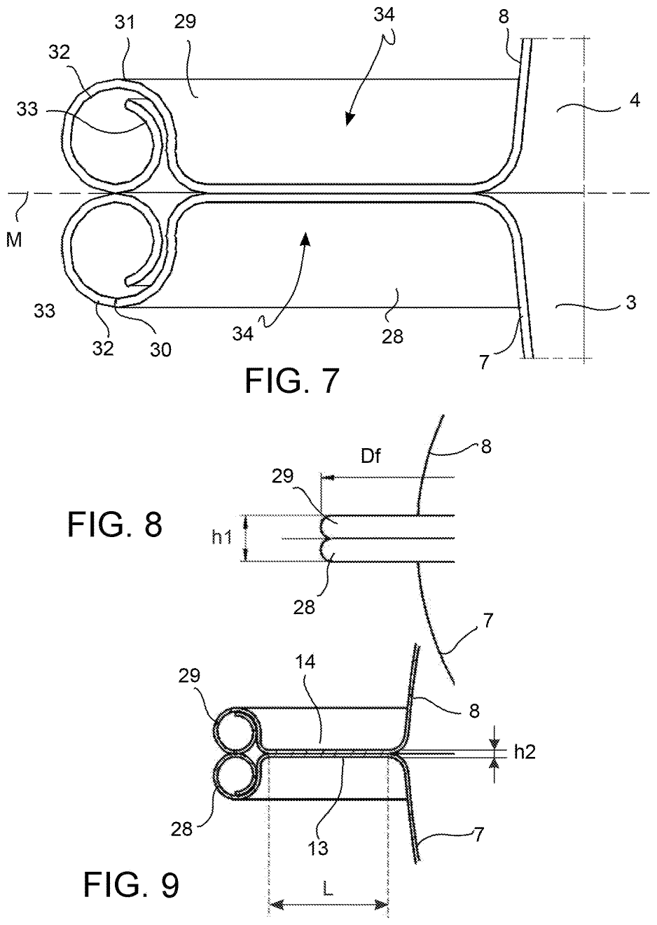

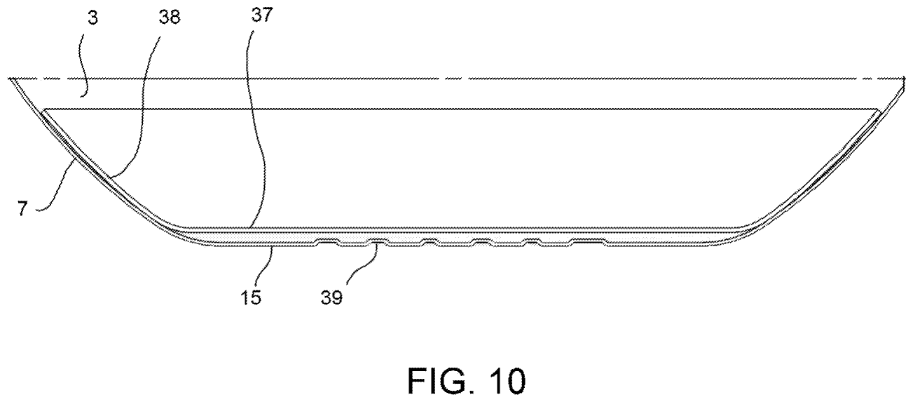

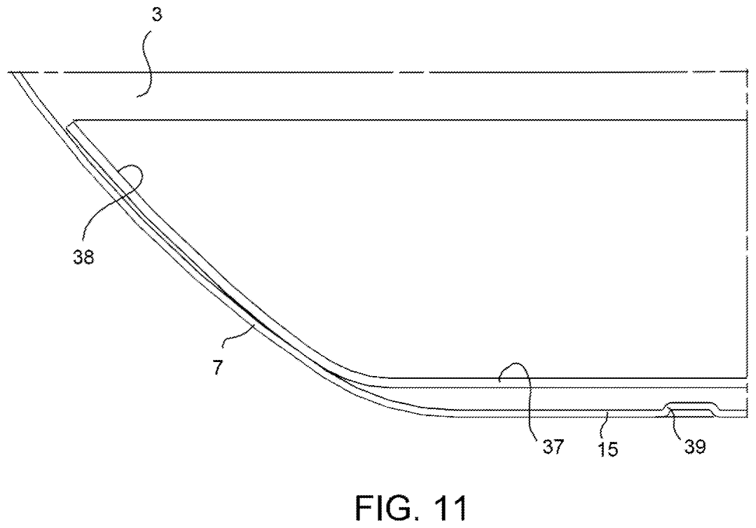

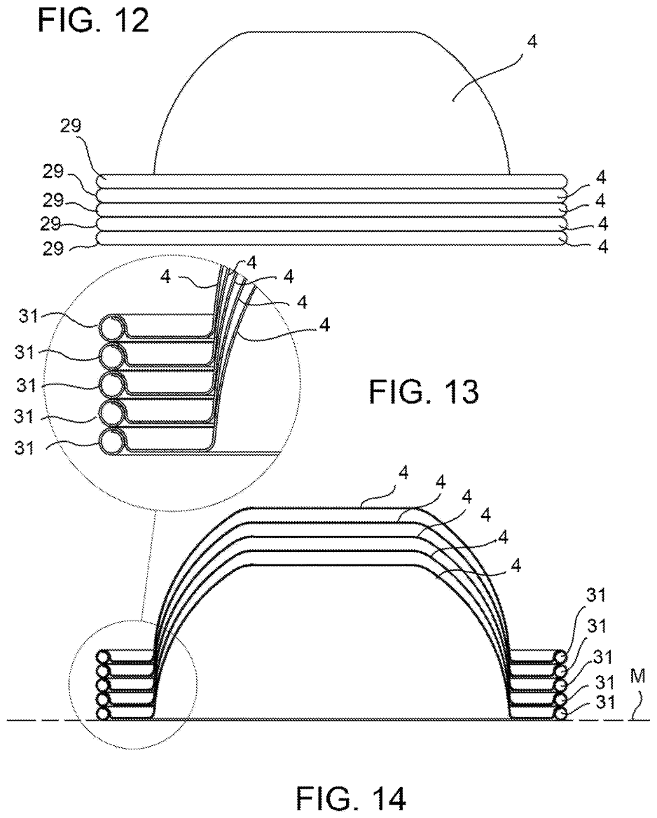

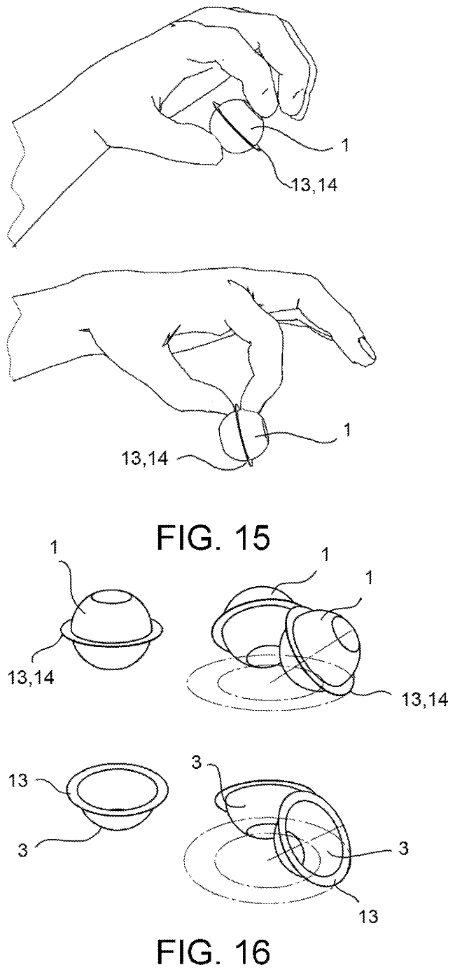

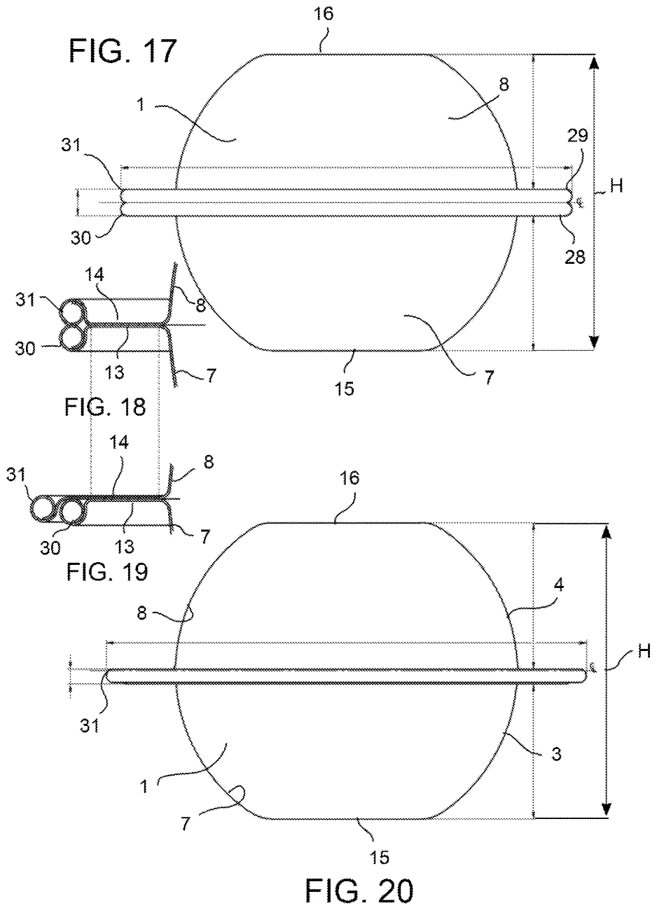

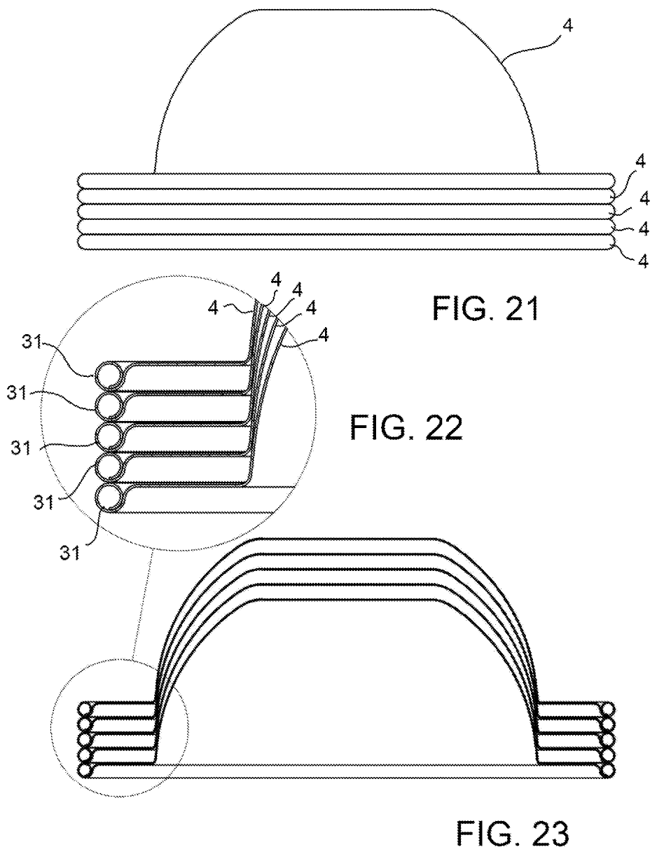

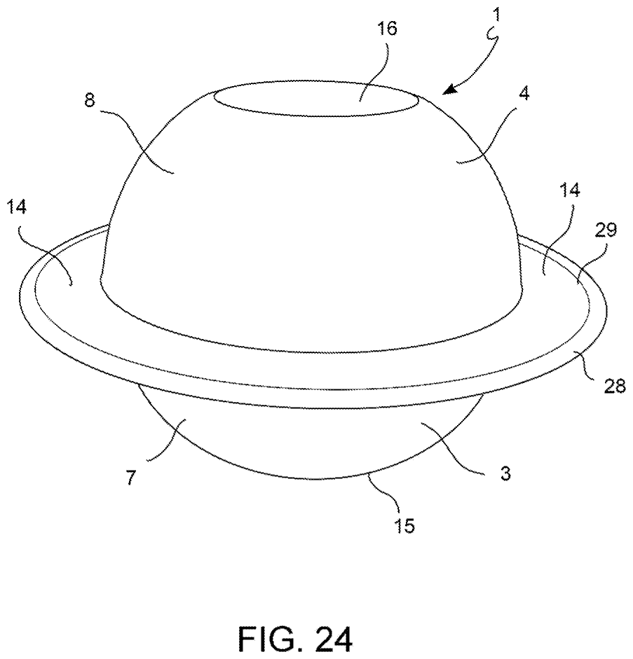

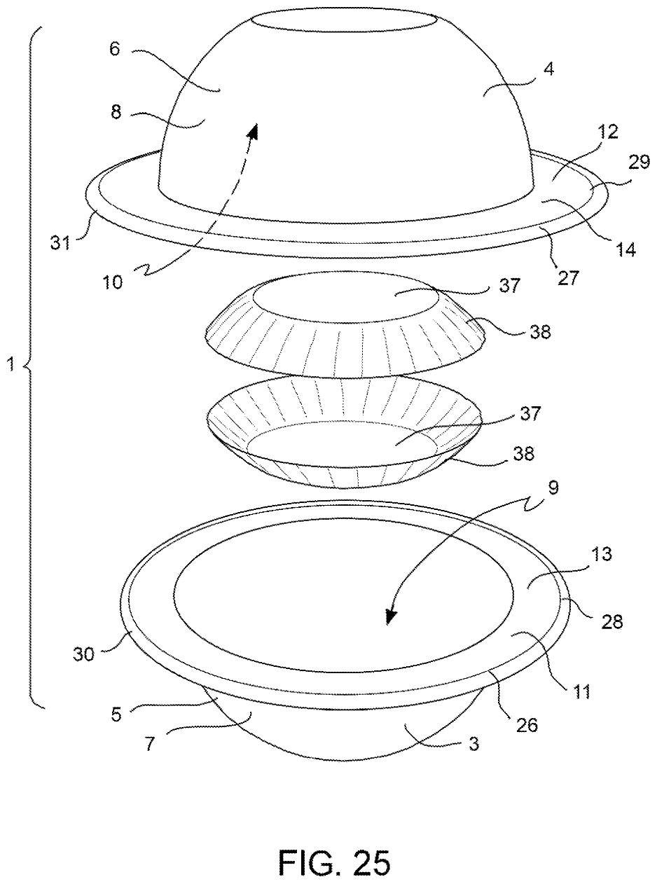

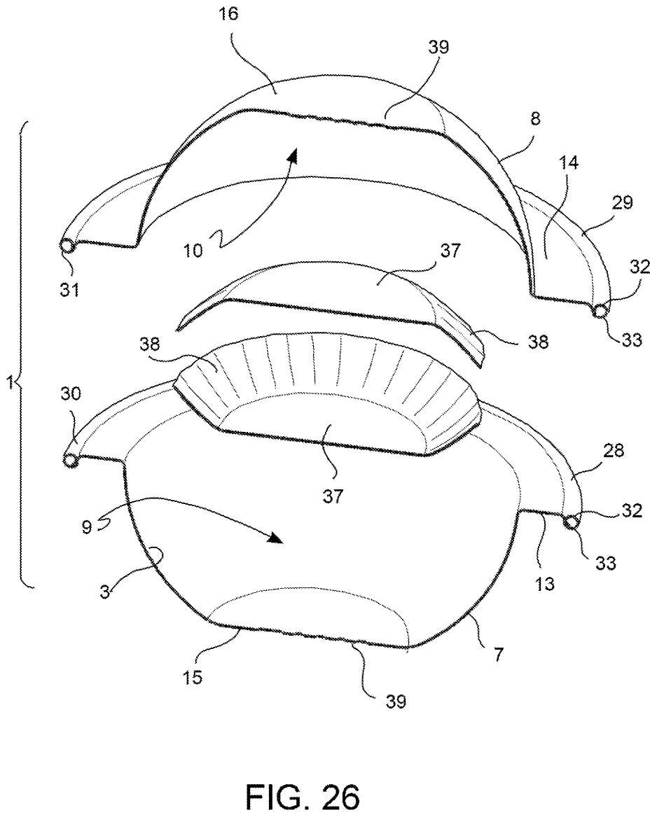

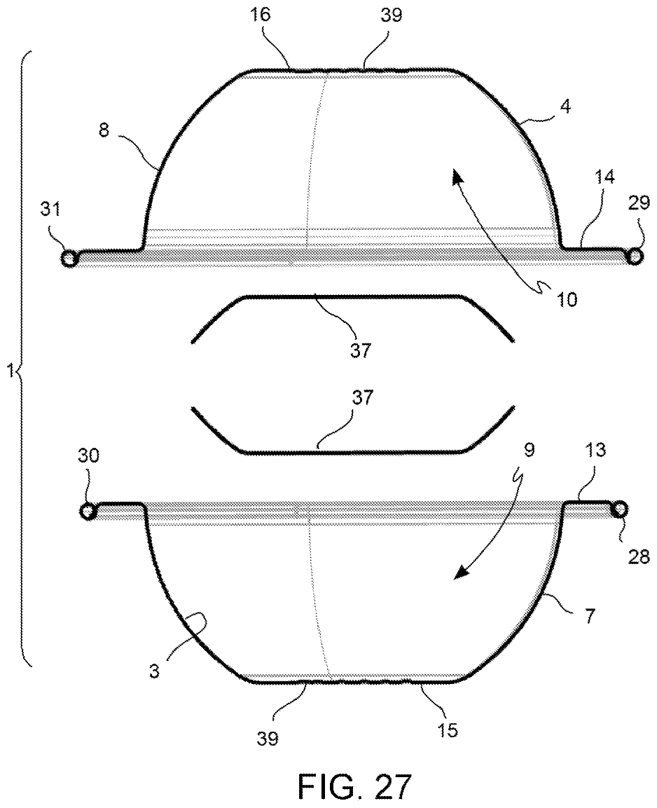

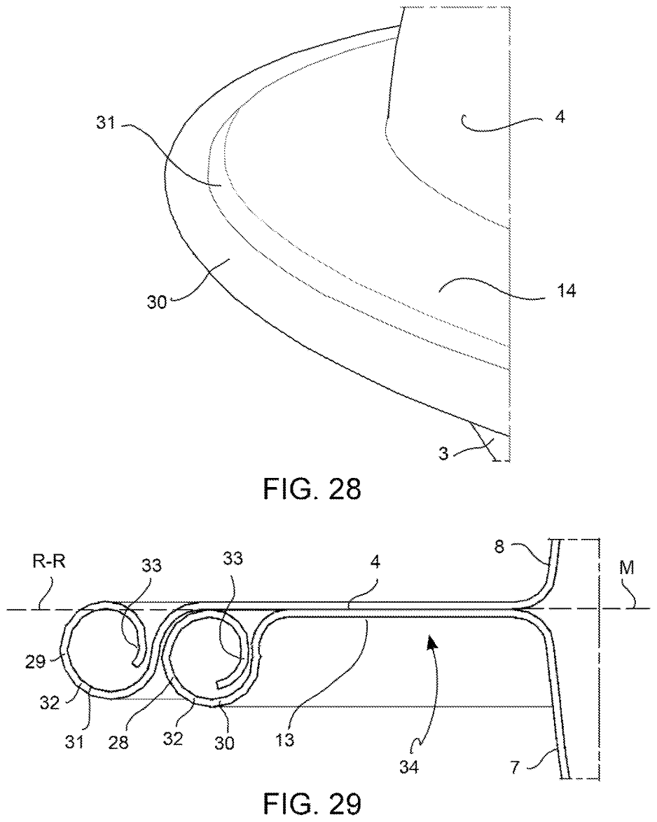

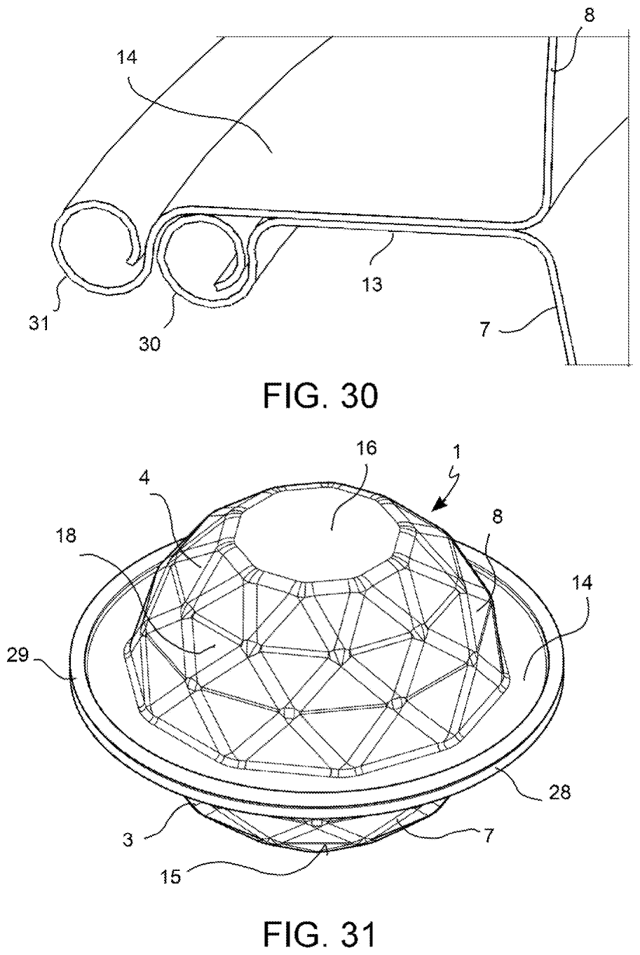

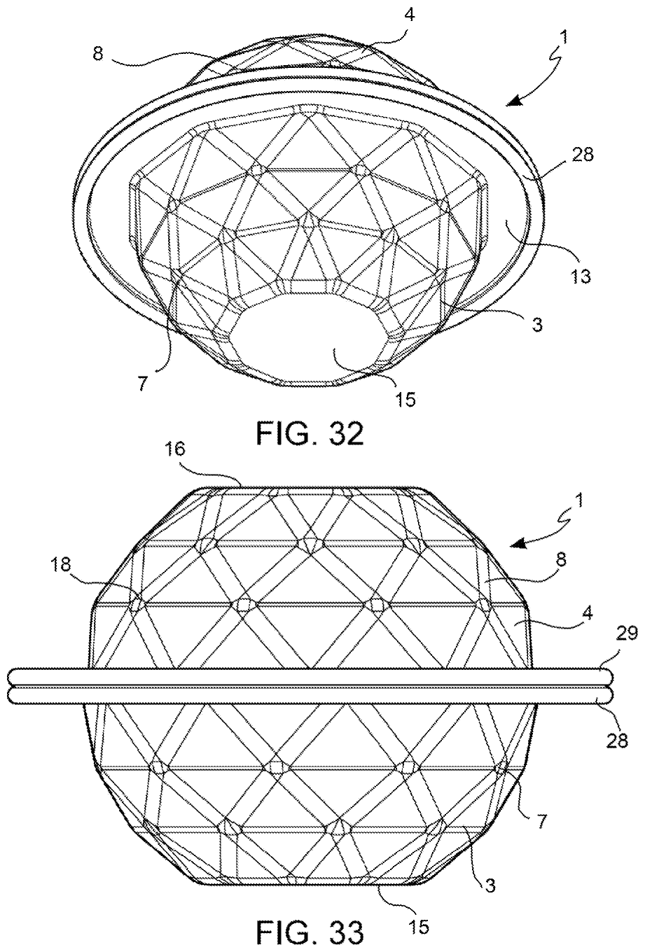

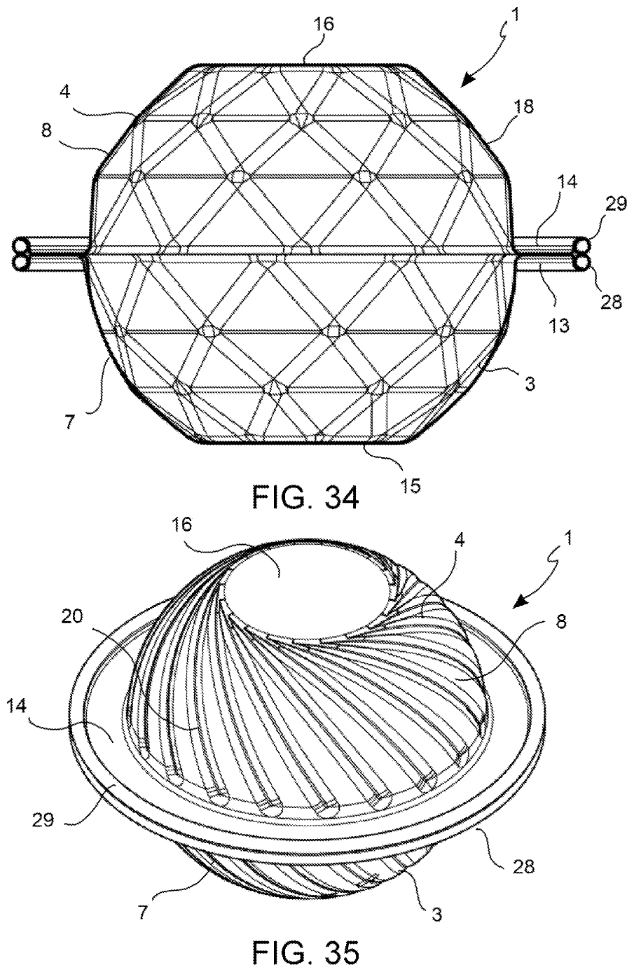

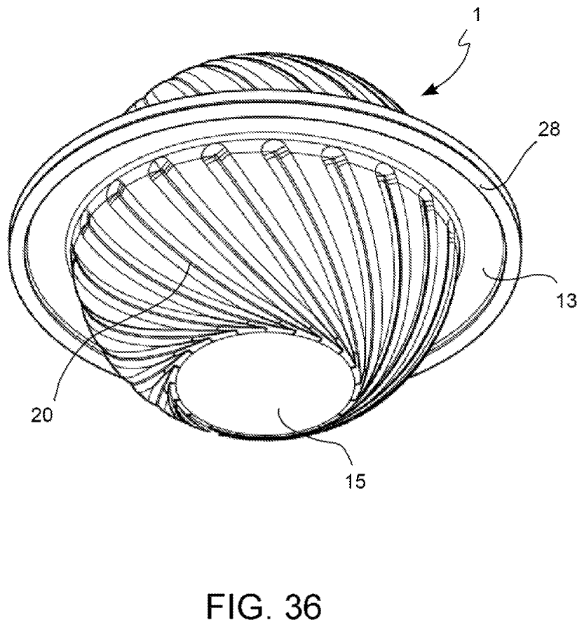

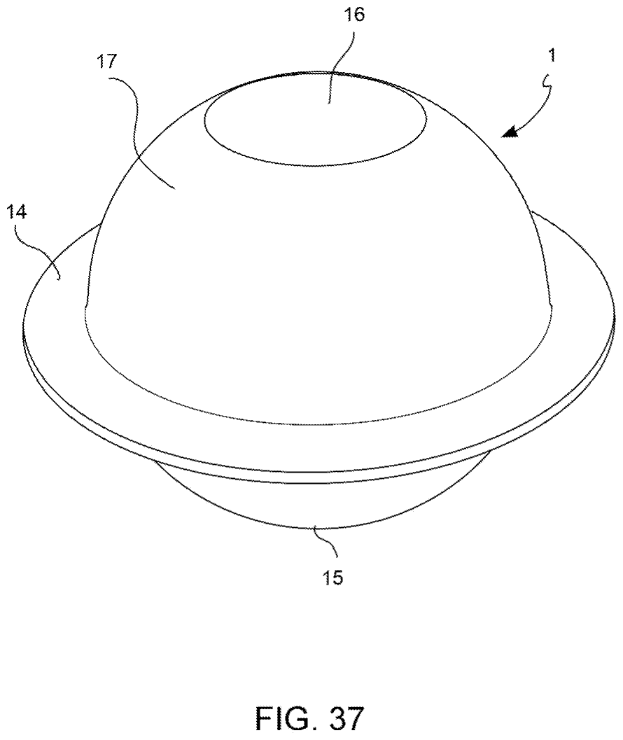

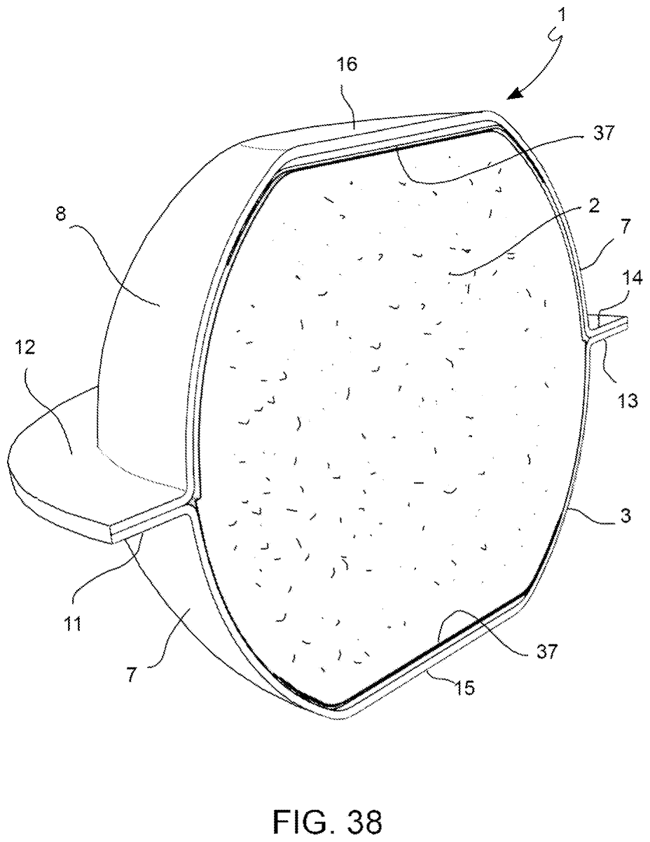

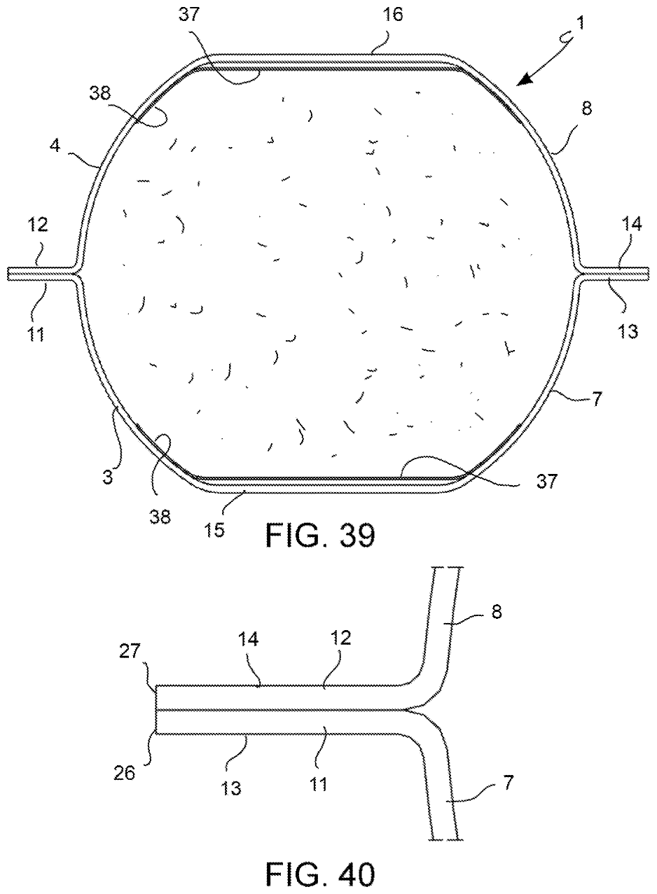

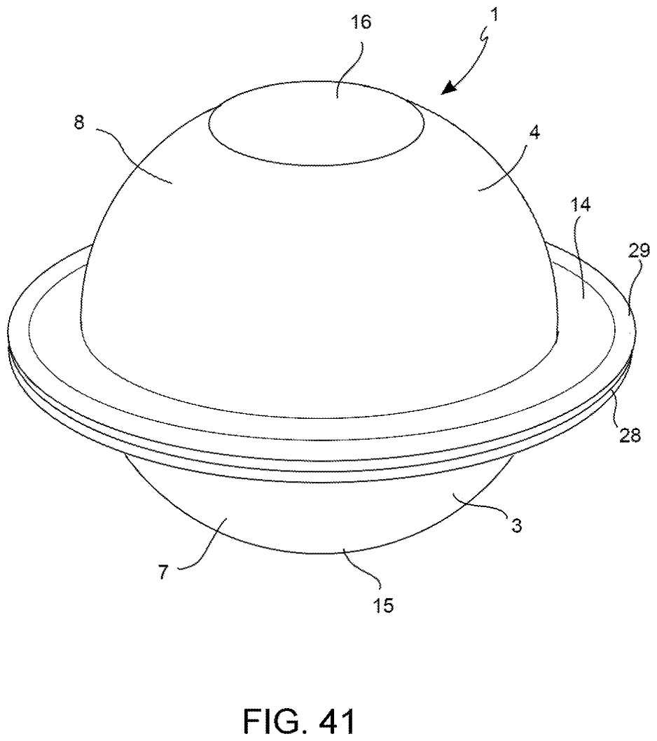

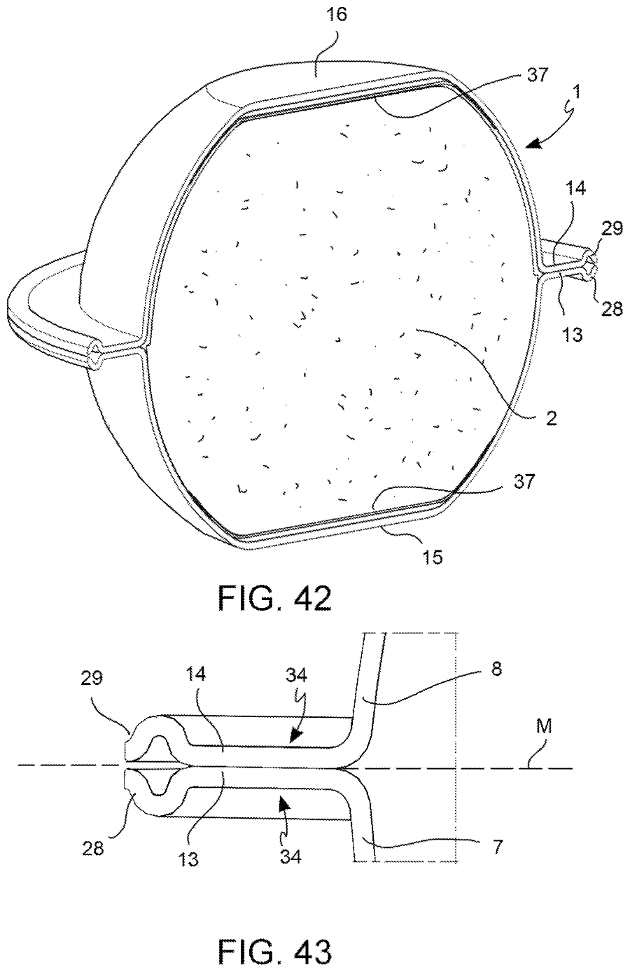

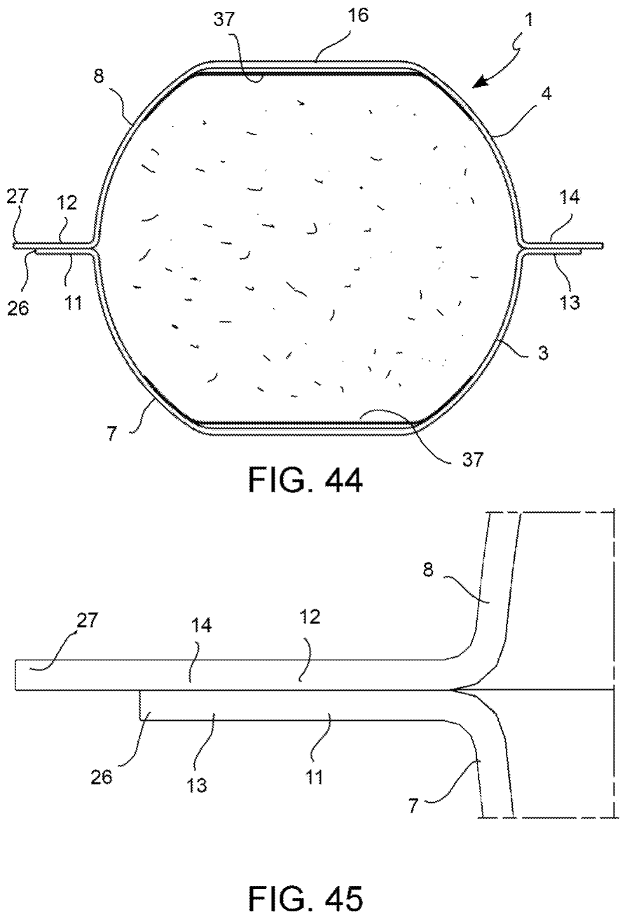

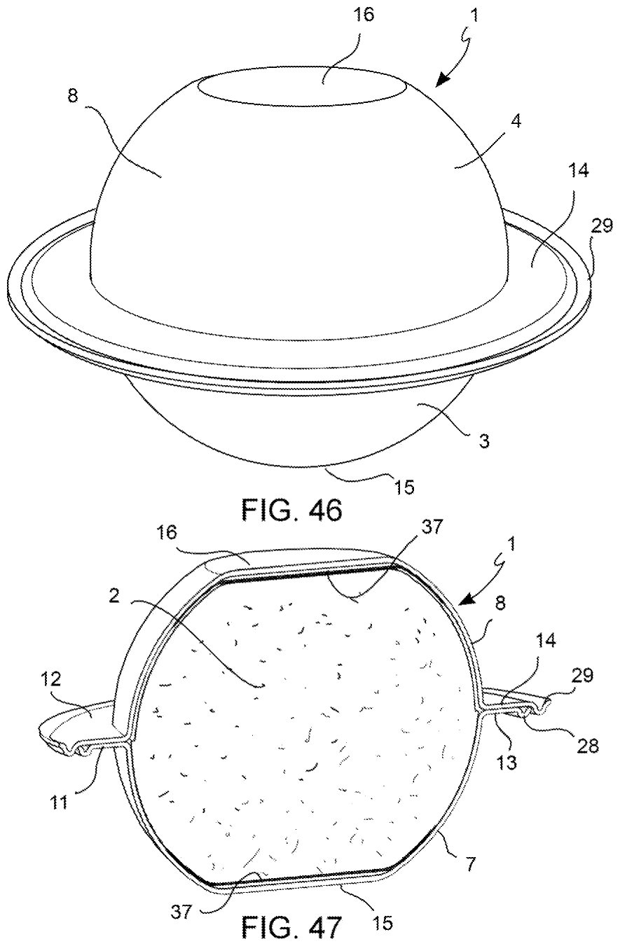

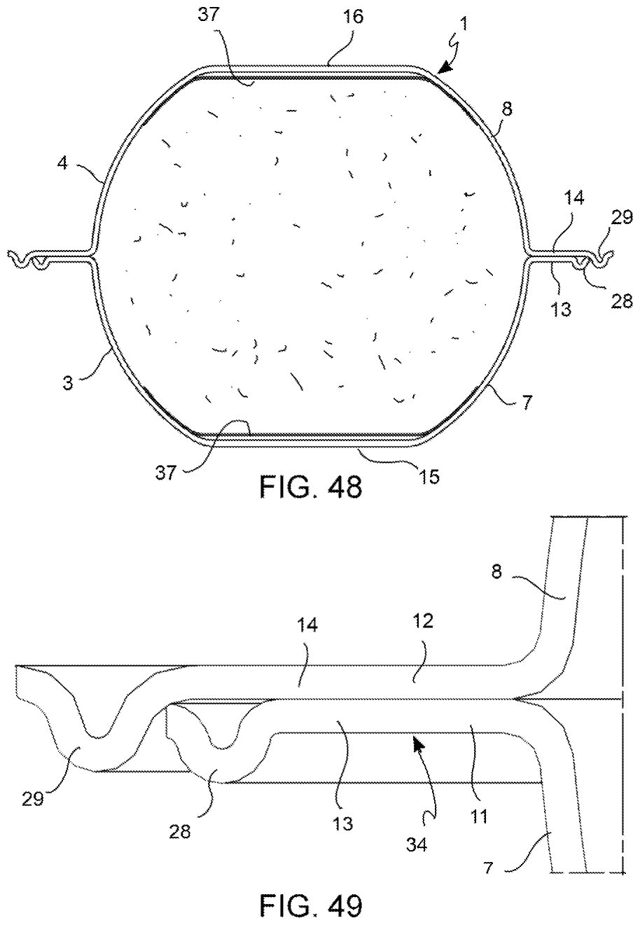

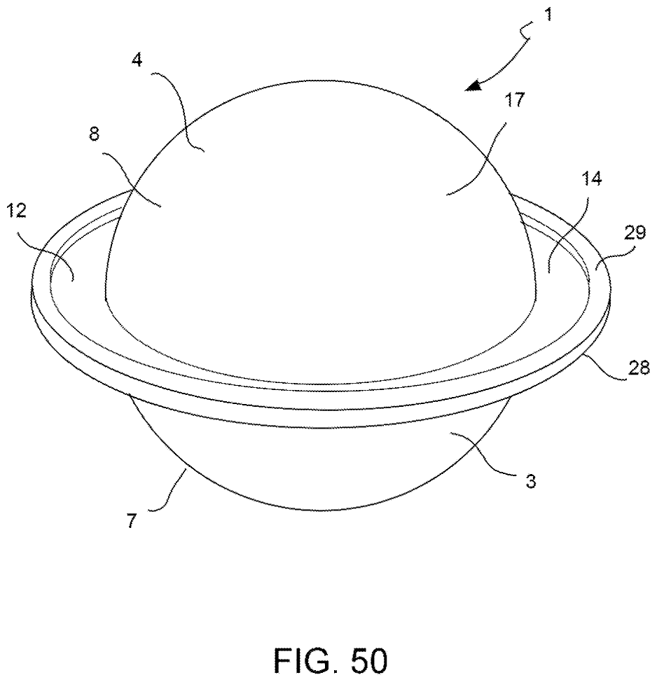

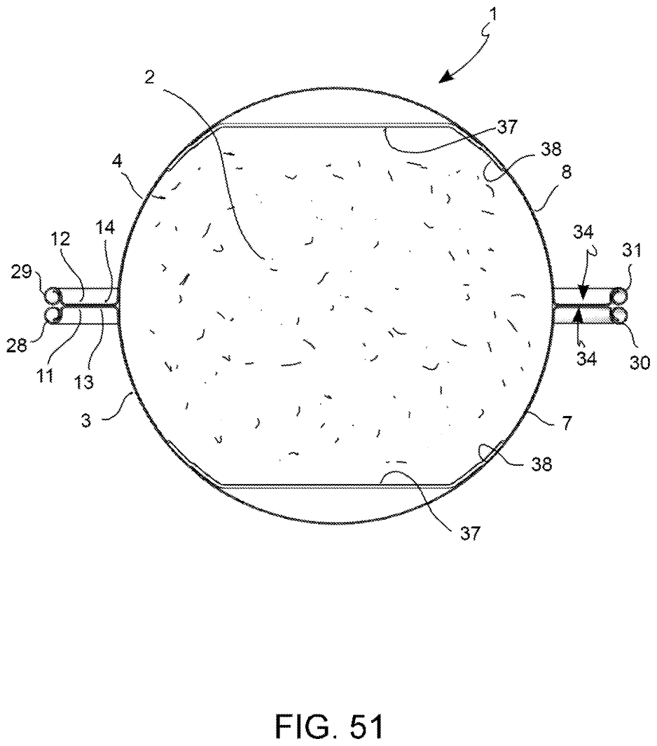

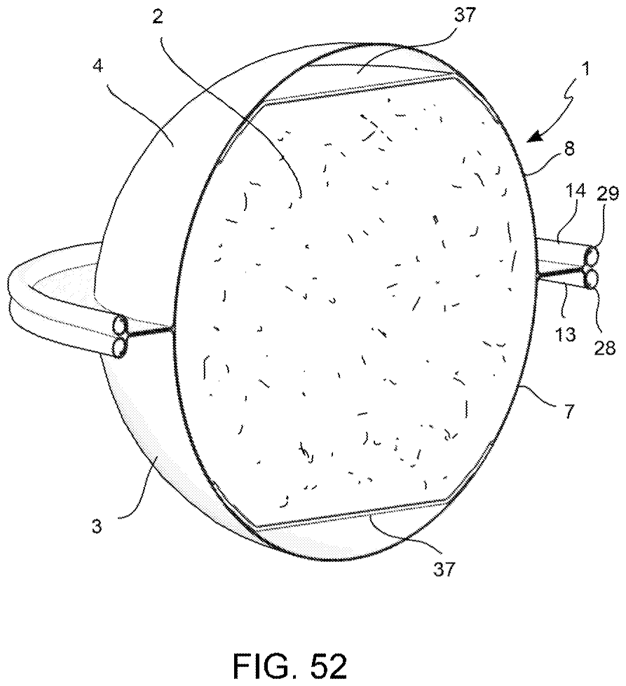

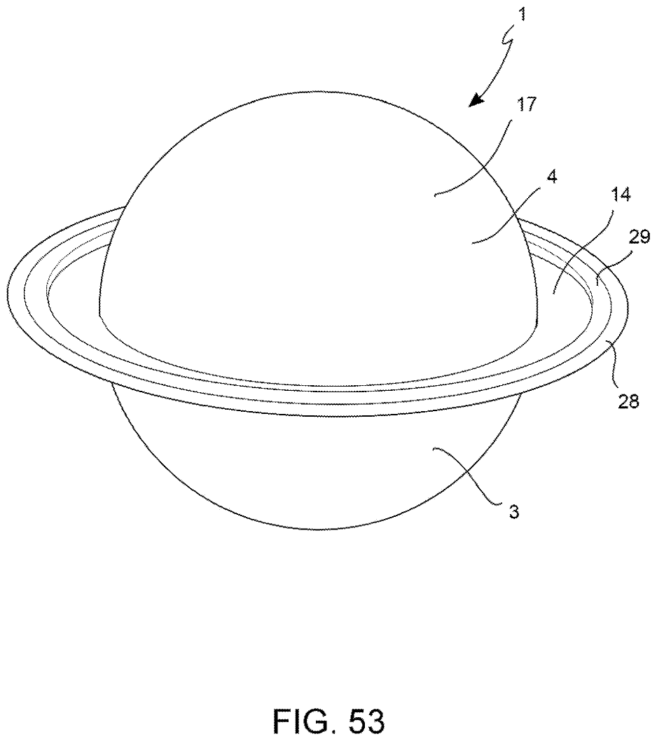

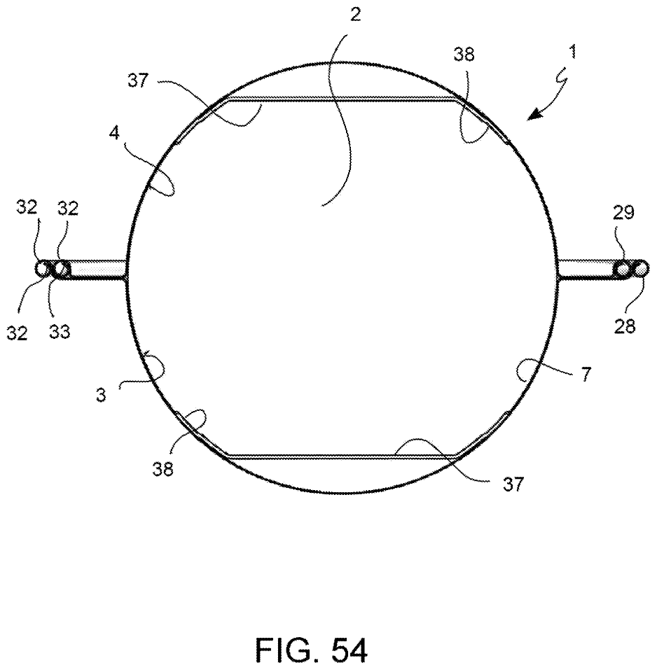

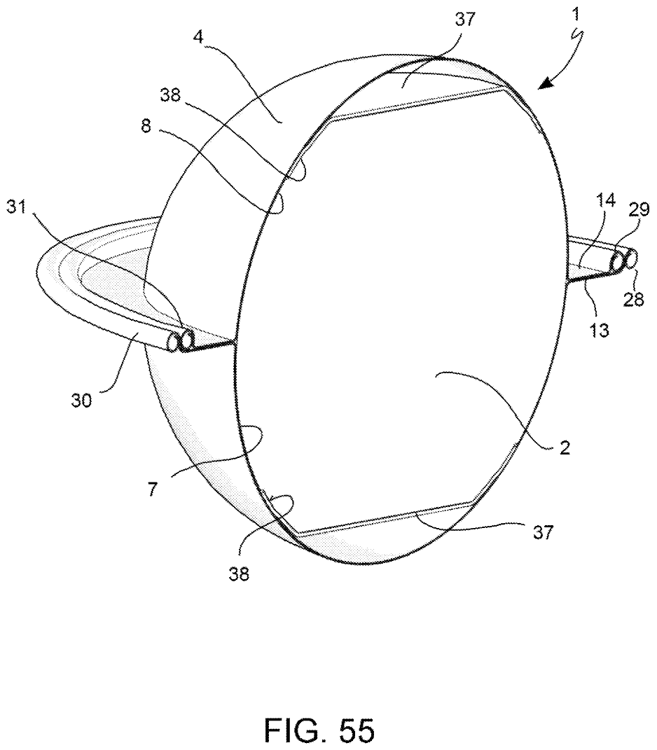

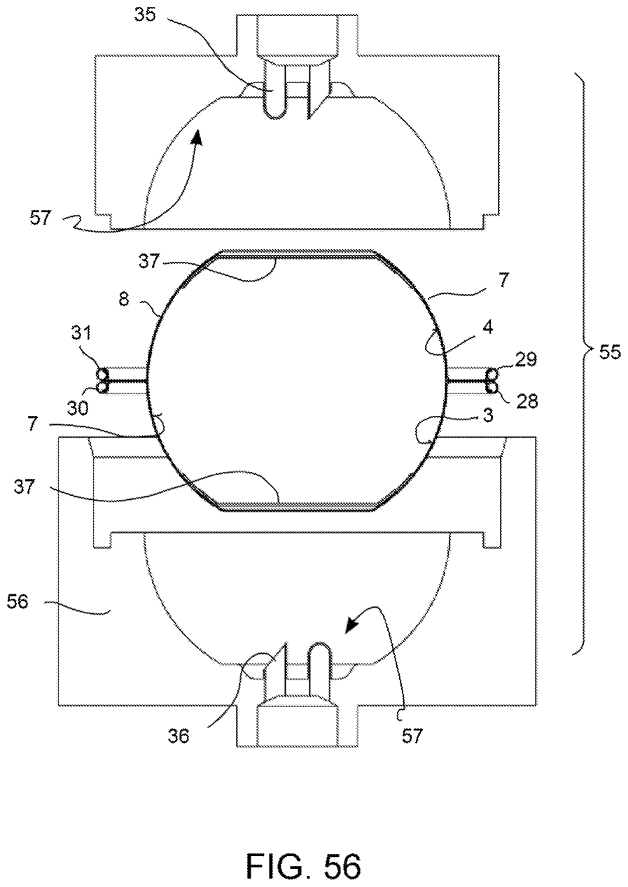

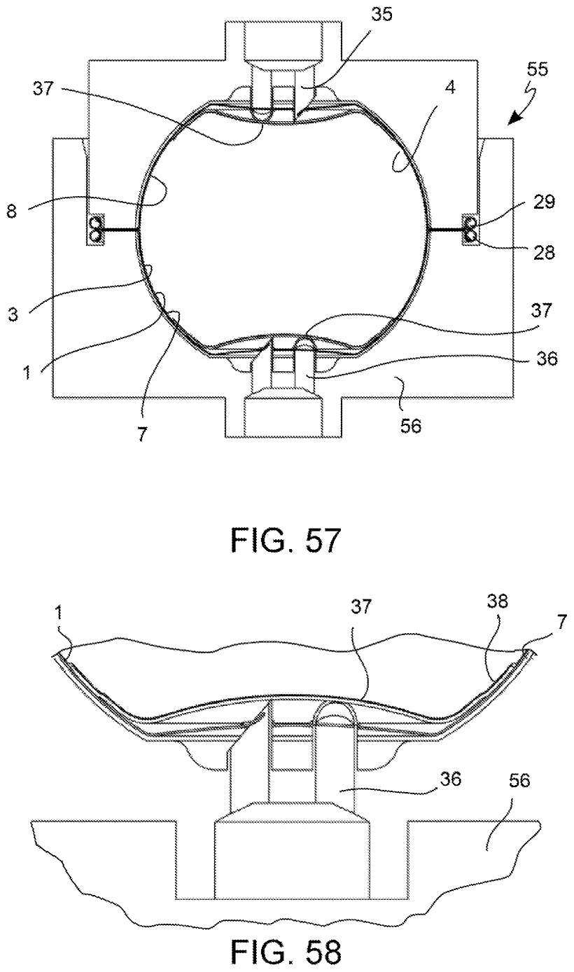

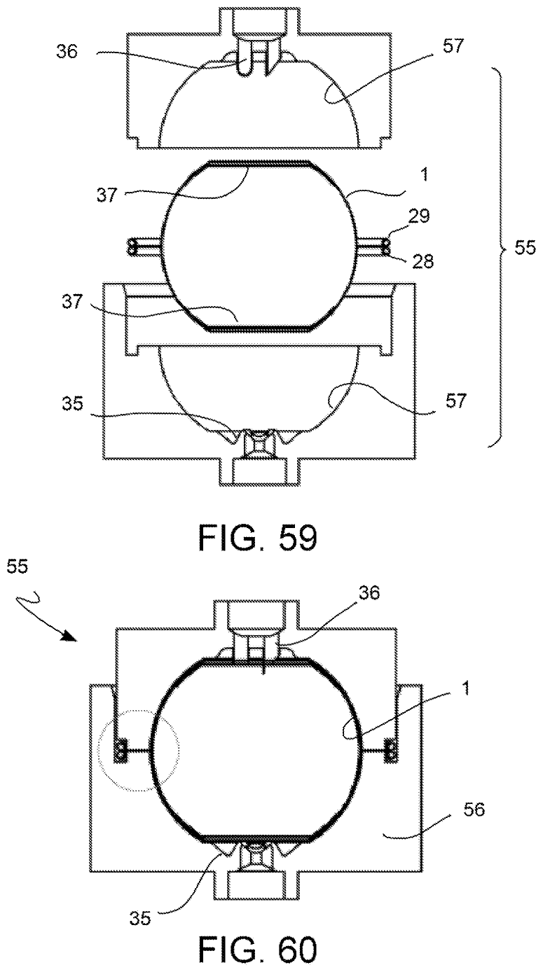

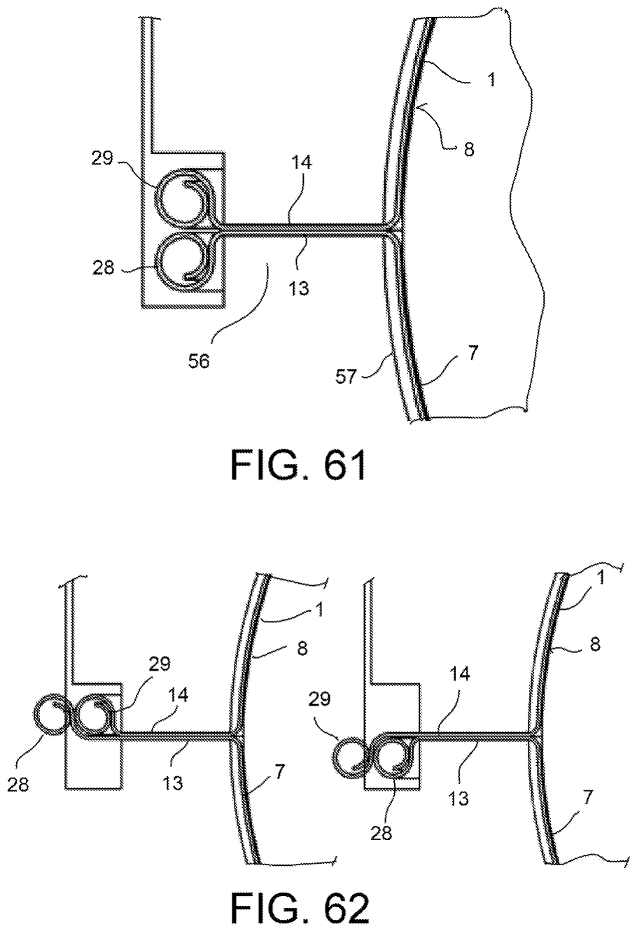

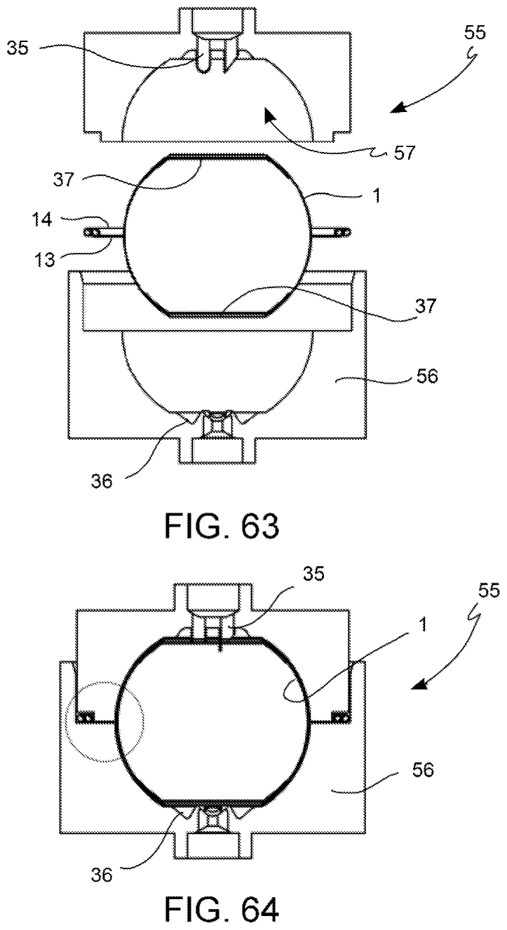

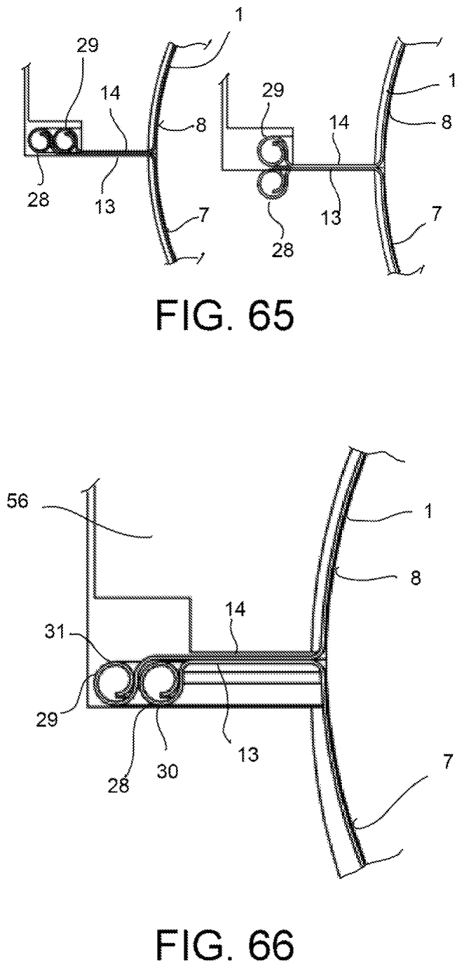

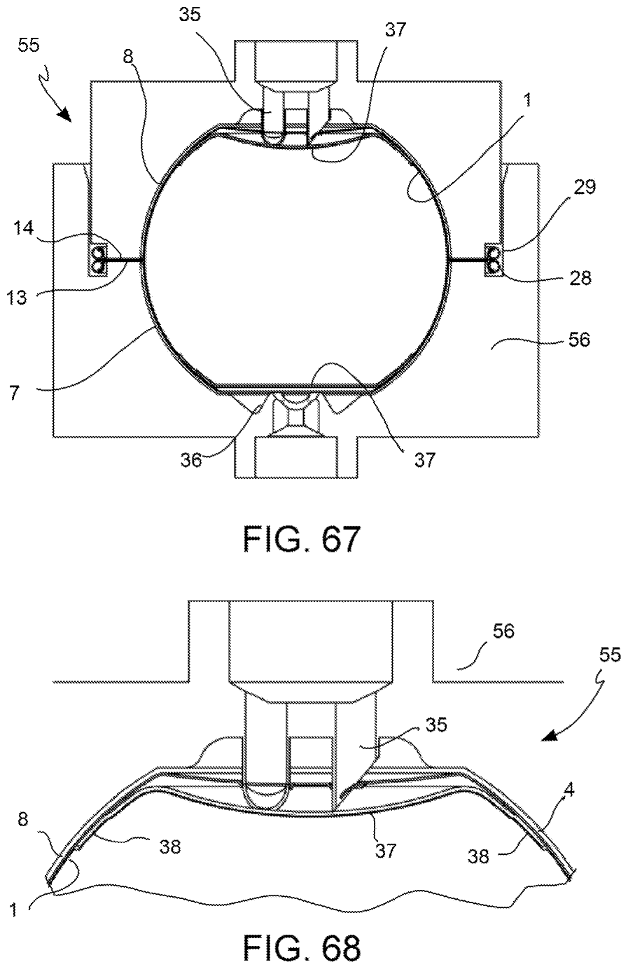

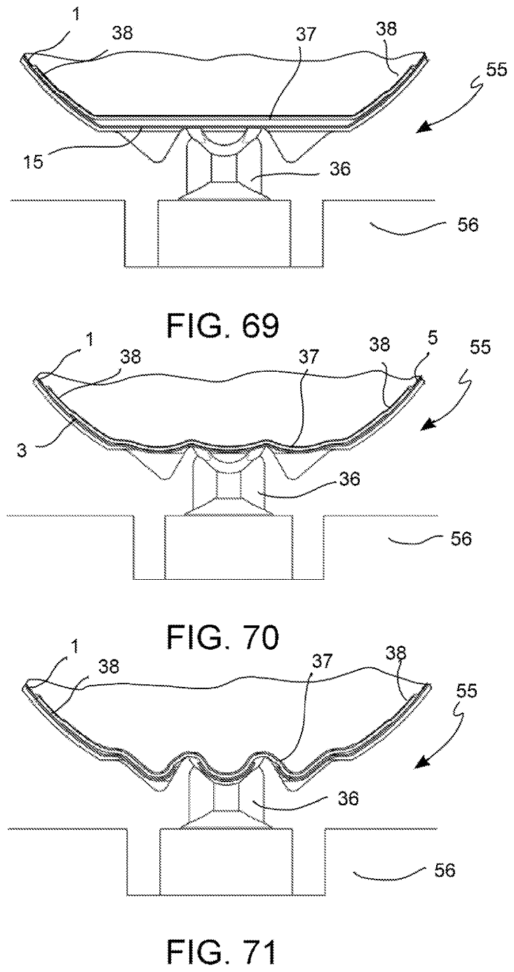

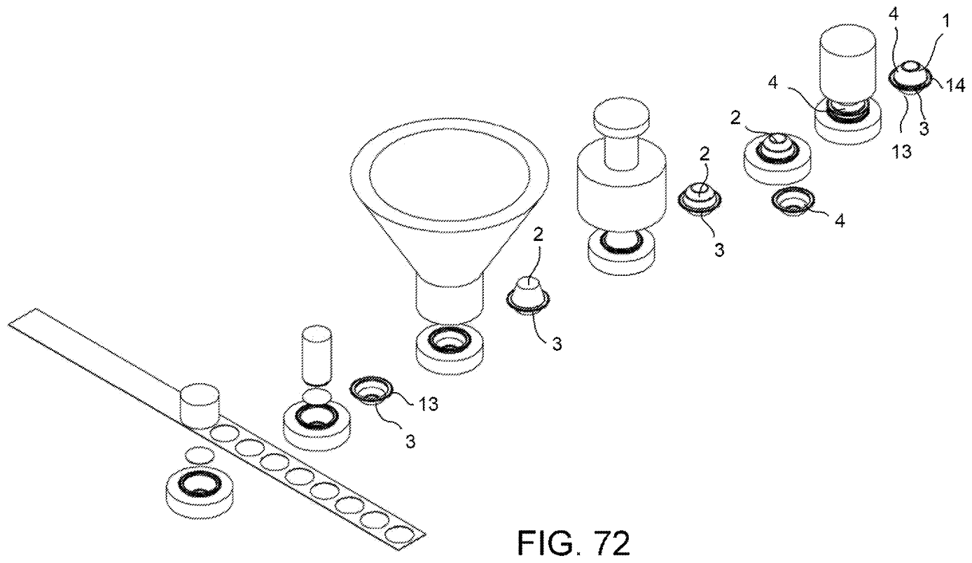

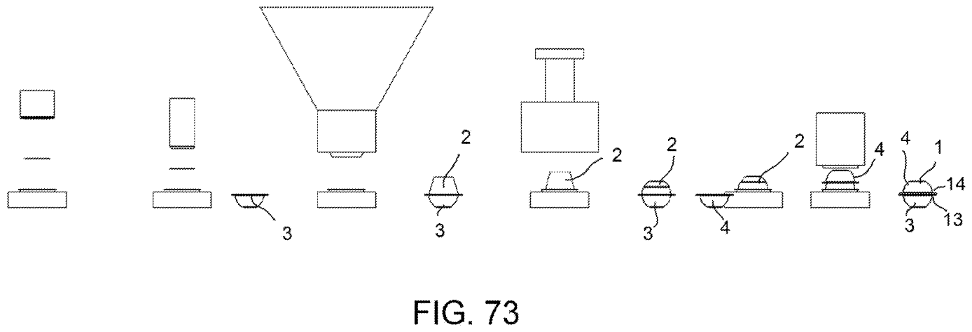

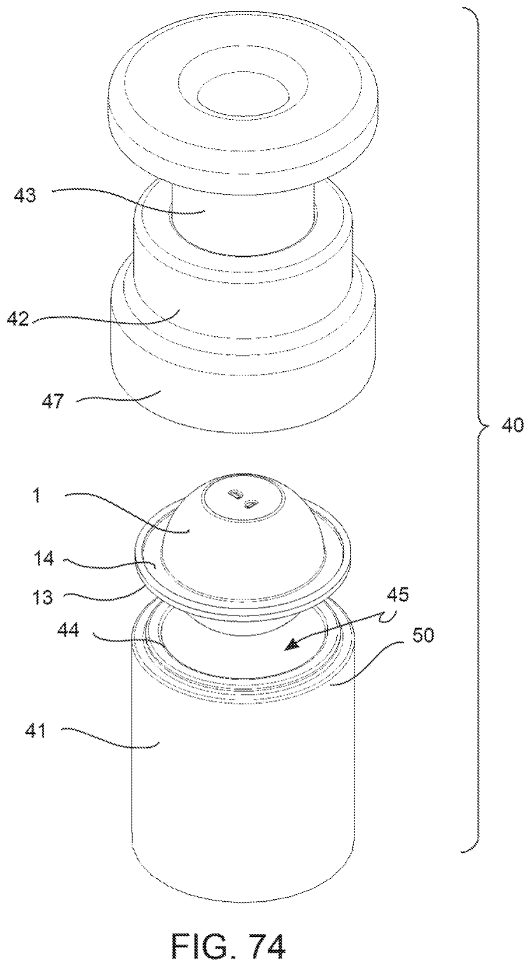

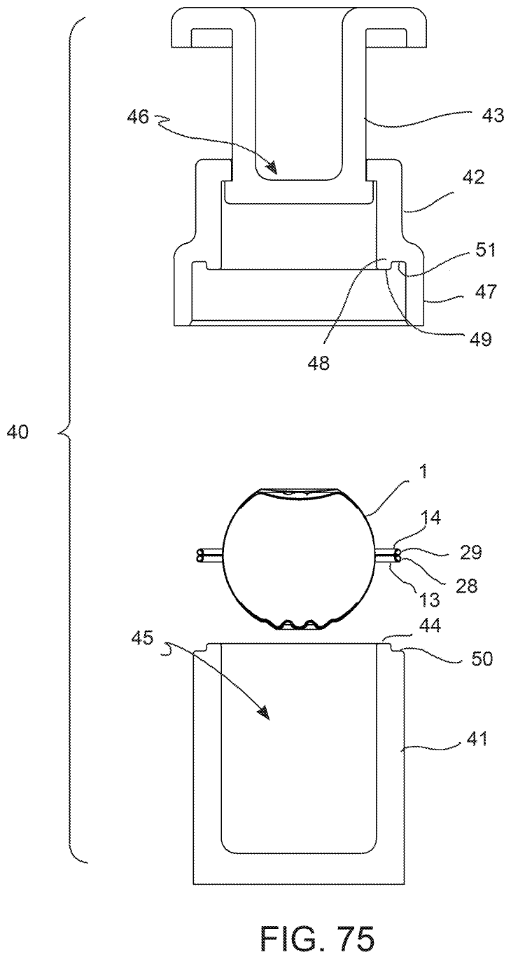

### DETAILED DESCRIPTION OF SOME PREFERRED EMBODIMENTS OF THE INVENTION

The present invention will now be described in detail with reference to the accompanying drawings to allow those skilled in the art to make and use it. Various changes to the embodiments described will be readily apparent to those skilled in the art and the general principles described can be applied to other embodiments and applications without departing from the scope of protection of the present invention, as defined in the appended claims. Therefore, the present invention should not be considered as limited to the embodiments described and shown, but should be granted the broadest scope of protection in compliance with the features described and claimed.

Unless otherwise defined, all the technical and scientific terms used herein have the same meaning commonly used by those of ordinary skill in the field to which the present invention pertains. In the case of a conflict, the present description, including the definitions provided, will be binding. Moreover, the examples are merely provided for illustrative purposes, and as such they should not be considered as limiting.

In order to facilitate the understanding of the embodiments described herein, reference will be made to some specific embodiments and a specific language will be used to describe them. The terminology used herein aims to describe only particular embodiments, and is not intended to limit the scope of the present invention.

Hereinafter, where the term “extractable product” is used, it will mean an extractable and/or soluble product, e.g., ground, roast and freeze-dried coffee, such as coffee, for example barley and ginseng.

Hereinafter, where the phrase “thin wall capsule forming mechanical resistance” is used, it will mean a wall capable of withstanding handling and slight knocks without being deformed, but unable to withstand the piercing by a flattened tool to create an opening. For example, a thin wall is understood to mean a wall made of metal sheet, which is commonly known for producing coffee capsules presently marketed. For example, a thin wall could also be paper or cellulose pulp or recyclable paper-based materials, home/industrial compostable coated with one or more barrier and heat-sealable layers.

Hereinafter, where the phrase “overall spherical volume or outline” is used, it is understood to mean any shape inscribed and circumscribed by two spherical caps apart from each other by less than 10% of the maximum diameter De of the outer spherical cap, preferably 5% of the maximum diameter De of the outer spherical cap. For example, overall spherical volume or outline is any shape inscribed and circumscribed by two spherical caps, apart from each other by less than 10% of the maximum diameter of the outer spherical cap, preferably 5% of the maximum diameter of the outer spherical cap, having the same center. This definition, according to an embodiment but not necessarily for all, also applies to the shape of the capsule after a pressurized fluid has been injected into it with a pressure from 0-22 bars, preferably from 5 to 12 bars, and even more preferably from 7 to 12 bars.

Hereinafter, where the phrase “thin capsule wall forming a barrier” is used, it is understood to mean a material impermeable to the acquisition or transmission of gases and humidity and provides a barrier, even a complete barrier, against fats, oils, and water. In addition, a material resistant to corrosion by substances with a pH value of between 4 and 9. An example of this barrier is materials comprising or consisting of aluminum or aluminum foils or foils with at least one aluminum layer. Aluminum foils thicker than 0.025 mm (0.001 inches) are impermeable to light, gases (including oxygen) and water vapor. Thinner foils become slightly permeable because of tiny holes caused by the production process, but in some cases they can be acceptable.

In addition, in the case of compostable and biodegradable packaging, e.g., cellulose based, this will be made of a material according to EN 13432 standard or a material with gas transmission rate (gas permeability), in particular with oxygen transmission rate (oxygen permeability), at 23° C. and a 50% relative humidity from 1 to 500 cm3/(m2 d bars), i.e., from 2 to 400 cm3/(m2 d bars), according to DIN 53380-3:1998-07 standard.

For example, material with water vapor transmission rate (water vapor permeability) at 23° C. and a 50% relative humidity from 15 to 100 g/(m2 d), i.e., from 20 to 80 g/(m2 d), according to ISO 7783:2018.

For example, a material with a water vapor transmission rate (water vapor permeability) at 23° C. and an 85% relative humidity from 20 to 250 g/(m2 d), i.e., 25 to 200 g/(m2 d), according to ISO 7783:2018.

For example, Material gas permeability means: OTR (Oxygen transmission rate)<0.5 cc/m2*day and WVTR (Water vapor transmission rate)<2 g/m2*day at tropical conditions.

According to a general embodiment, a capsule 1 for preparing a predetermined amount of beverage suitable for consumption using an extractable product 2, e.g., ground coffee, comprising a first and a second half-capsule 3, 4.

Each half-capsule 3, 4 comprises a thin capsule wall 5, 6.

Said thin capsule wall 5, 6 forms in one piece a first thin wall portion 7, 8 delimiting a substantially spherical shape inner half-chamber 9, 10.

Said capsule wall 5, 6 close to the greater dimension D thereof forms, in one piece with said first thin wall portion 7, 8, a second thin wall portion 11, 12 which bends to form an annular flange 13, 14.

Said two half-capsules 3, 4 are arranged facing each other and mutually specular so as to contact at least one portion of said annular flange 13, 14 where they are joined to each other.

Said first thin wall portions 7, 8 have outlines with substantially identical volume.

Said specularly facing first thin wall portions 7, 8 substantially form an outline with an overall substantially spherical volume with truncated poles 15, 16.

According to a general embodiment, a capsule 1 for preparing a predetermined amount of beverage suitable for consumption using an extractable product 2, e.g., ground coffee, comprising a first and a second half-capsule 3, 4.

Each half-capsule 3, 4 comprises a thin capsule wall 5, 6 capable of mechanical resistance and substantially forming a barrier to air, in particular, to oxygen and humidity.

For example, said thin capsule wall 5, 6 can be punctured with a tool, such as a needle or a knife and if gripped with your hands, can resist weak pressure.

Said thin capsule wall 5, 6 forms in one piece a first thin wall portion 7, 8 delimiting a substantially hemispherical inner half-chamber 9, 10 adapted to contain said extractable product 2.

Said capsule wall 5, 6, close to the greater dimension D thereof, or the equatorial diameter, of the inner half-chamber 9, 10, forms a second thin wall portion 11, 12 in one piece with said first thin wall portion 7, 8 which bends to form an annular flange 13, 14 radially R-R and externally projecting away from said first thin wall portion 7, 8.

Said two half-capsules 3, 4 are arranged facing each other and mutually specular so as to contact at least one portion of said annular flange 13, 14 where they are joined to each other.

Said first thin wall portions 7, 8 have outlines with substantially identical volume.

Said specularly facing first thin wall portions 7, 8 substantially form an outline with an overall substantially spherical volume with truncated poles 15, 16.

According to an embodiment, said truncated poles 15, 16 are with thin wall portions 7, 8 far from said greater dimension D.

According to an embodiment, each of said truncated poles 15, 16, when intact before extraction, comprises a segment of said thin capsule wall 5, 6 forming a plane, or a slightly concave segment, which is brought slightly towards the inside of said first thin wall portion 7, 8.

According to an embodiment, said first thin wall portions 7, 8, except for said truncated poles 15, 16, form an outline substantially equally spaced apart from a capsule center C.

According to an embodiment, said mutually facing first thin wall portions 7, 8 substantially form a sphere with truncated poles 15, 16, each forming a hemispherical cap outline with a truncated pole.

According to an embodiment, said facing first thin wall portions 7, 8 form a first and a second inner half-chamber 9, 10, jointly delimiting a single inner chamber 25 with a substantially spherical outline with truncated poles.

According to an embodiment, said thin capsule wall 5, 6 is made of a rigid or semi-rigid material.

According to an embodiment, said thin capsule wall 5, 6 comprises at least one aluminum layer.

According to an embodiment, said thin capsule wall 5, 6 comprises at least one aluminum layer and is obtained by deep drawing.

According to an embodiment, said thin capsule wall 5, 6 comprises a uniform thickness. The term “uniform thickness” is understood to mean a substantially constant thickness, i.e., a constant thickness except for the differences in thickness generated by the deep drawing operation, or similar process, and specific weakness points created to facilitate the opening of the capsule. For example, the uniform thickness is obtained substantially starting from a sheet having a constant uniform thickness and proceeding with deep drawing. With operations like these, e.g., deep drawing, the thickness can vary by 10-15%. According to an embodiment, the thin wall thickness can vary from 60 to 300 micrometers. According to an embodiment, the thickness is 100 micrometers, at least 70 micrometers of which being metal, e.g., aluminum. According to an embodiment, the thickness is 300 micrometers with at least 200 micrometers of cellulose.

According to an embodiment, said truncated poles 15, 16 of said facing half-capsules 3,4 have identical dimensions to each other.

According to an embodiment, said first thin wall portions 7, 8 with said truncated poles 15, 16 of said first and second half-capsules 3, 4 are mutually identical.

According to an embodiment, said first and said second half-capsule 3, 4 are mutually identical.

According to an embodiment, each annular flange 13, 14 comprises a flat flange segment 15, 16.

According to an embodiment, each annular flange 13, 14 comprises a flat flange segment 15, 16. Said two half-capsules 3, 4 are arranged facing each other and mutually specular so as to contact at least one portion of said flat flange segment 15, 16.

According to an embodiment, said capsule 1 has a specular shape with respect to a median plane M thereof. According to an embodiment, said median plane passes through a point equally spaced apart from said truncated poles 15, 16.

According to an embodiment, said first and second half-capsules 3, 4 specularly face each other with the concavities thereof mutually facing to form a first and a second inner half-chamber 9, 10, together forming a single inner chamber 25, which is substantially spherical with truncated poles 15, 16.

According to an embodiment, the assembly of said first thin wall portion 7, 8 of first and second half-capsules has a spherical outline 17.

According to an embodiment, the assembly of said first thin wall portion 7, 8 of first and second half-capsules has a spherical outline 17 with truncated poles 15, 16.

According to an embodiment, the assembly of said first thin wall portion 7, 8 of first and second half-capsules has an outline contained between two spheres, one circumscribed and external and one inscribed and internal, the difference in diameter of which is less than 10% preferably less than 5%

According to an embodiment, the assembly of said first thin wall portion 7, 8 of first and second half-capsules has an outline contained between two spheres with truncated poles 15, 16, one circumscribed and external and one inscribed and internal, the difference in diameter of which is less than 10%, preferably less than 5%.

According to an embodiment, the assembly of said first thin wall portion 7, 8 of first and second half-capsules has a spherical polyhedron outline 18.

According to an embodiment, the assembly of said first thin wall portion 7, 8 of first and second half-capsules has a spherical polyhedron outline 18 with truncated poles 15, 16.

According to an embodiment, the assembly of said first thin wall portion 7, 8 of first and second half-capsules has a spherical polyhedron outline 18 with flat faces.

According to an embodiment, the assembly of said first thin wall portion 7, 8 of first and second half-capsules has a spherical polyhedron outline 18 with flat faces and truncated poles 15, 16.

According to an embodiment, the assembly of said first thin wall portion 7, 8 of first and second half-capsules has a spherical polyhedron outline 18 with flat faces, where each face is a triangle.

According to an embodiment, the assembly of said first thin wall portion 7, 8 of first and second half-capsules has a spherical polyhedron outline 18 with flat faces with truncated poles 15, 16, where each face is a triangle.

According to an embodiment, the assembly of said first thin wall portion 7, 8 of first and second half-capsules has a spherical polyhedron outline 18 with flat faces, where each face is a pentagon.

According to an embodiment, the assembly of said first thin wall portion 7, 8 of first and second half-capsules has a spherical polyhedron outline 18 with flat faces with truncated poles 15, 16, where each face is a pentagon.

According to an embodiment, the assembly of said first thin wall portion 7, 8 of first and second half-capsules has a spherical polyhedron outline 18 with flat faces, where each face is a circle.

According to an embodiment, the assembly of said first thin wall portion 7, 8 of first and second half-capsules has a spherical polyhedron outline 18 with flat faces with truncated poles 15, 16, where each face is a circle.

According to an embodiment, the assembly of said first thin wall portion 7, 8 of first and second half-capsules has a spherical outline 17 with bosses 19.

According to an embodiment, the assembly of said first thin wall portion 7, 8 of first and second half-capsules has a spherical outline 17 with truncated poles 15, 16 and with bosses 19.

According to an embodiment, the assembly of said first thin wall portion 7, 8 of first and second half-capsules has a spherical outline 17 with spiral grooves 20.

According to an embodiment, the assembly of said first thin wall portion 7, 8 of first and second half-capsules has a spherical outline 17 with truncated poles 15, 16 and with grooves 20.

According to an embodiment, the assembly of said first thin wall portion 7, 8 of first and second half-capsules has a spherical outline 17 with meridian grooves 21.

According to an embodiment, the assembly of said first thin wall portion 7, 8 of first and second half-capsules has a spherical outline 17 with meridian grooves 21 and truncated poles 15, 16.

According to an embodiment, the assembly of said first thin wall portion 7, 8 of first and second half-capsules has a spherical outline 17 with parallel grooves 22.

According to an embodiment, the assembly of said first thin wall portion 7, 8 of first and second half-capsules has a spherical outline 17 with parallel grooves 22 and truncated poles 15, 16.

According to an embodiment, the assembly of said first thin wall portion 7, 8 of first and second half-capsules has a spherical outline 17 with spiral grooves 23.

According to an embodiment, the assembly of said first thin wall portion 7, 8 of first and second half-capsules has a spherical outline 17 with spiral grooves 23 and truncated poles 15, 16.

According to an embodiment, the assembly of said first thin wall portion 7, 8 of first and second half-capsules has a spherical outline 17 with steps 24.

According to an embodiment, the assembly of said first thin wall portion 7, 8 of first and second half-capsules has a spherical outline 17 with steps 24 and truncated poles 15, 16.

According to an embodiment, said capsule 1 has a difference between the maximum equatorial diameter D and the pole distance H, measured between said truncated poles 15, 16 of less than 10%, preferably 5%.

According to an embodiment, the ratio between the distance of the truncated poles 15, 16 and the maximum equatorial diameter D is from 90% to 75%.

According to an embodiment, said truncated poles 15, 16 are equally spaced apart from a center C of the pair of first thin wall portions 7, 8 of first and second half-capsules.

According to an embodiment, said at least one portion of said annular flange 13, 14 of the two half-capsules 3, 4 positioned mutually in contact are heat-sealed to each other so that the inner chamber 25 formed by said first and second inner half-chambers 9, 10 is sealed from the environment outside the capsule 1.

According to an embodiment, at least one of said annular flanges 13 or 14 of said half-capsules 3 or 4 comprises a free flange end edge 26 or 27 forming a flange ring 28 or 29, where said flange ring 28 or 29 comprises a ring thickness h1, or height in the direction orthogonal to said median M separation plane between the two half-capsules 3, 4, which is greater than the height, or the flange thickness h2, or the height in the direction orthogonal to said median M separation plane between the two half-capsules 3, 4, of said portion of said annular flange 13 or 14 placed in contact with the adjacent half-capsule 4 or 3.

According to an embodiment, at least one of said annular flanges 13 or 14 of said half-capsules 3 or 4 comprises a free flange end edge 26 or 27, which forms a flange ring 28 or 29, where said flange ring 28 or 29 comprises an overall ring thickness greater than the thickness of said portion of said annular flange 13 or 14, placed in contact with the adjacent half-capsule 4 or 3.

According to an embodiment, both half-capsules 3 and 4 comprise said flange ring 28 and 29.

According to an embodiment, both half-capsules 3 and 4 comprise said flange ring 28 and 29 and said flange rings 28, 29 are arranged specularly to each other.

According to an embodiment, both half-capsules 3 and 4 comprise said flange ring 28 and 29 arranged side-by-side in the radial direction R-R, where, according to an embodiment, the radial direction is evaluated as the radial direction of the spherical outline of said first thin wall portion 7, 8 of first or second half-capsule, or of the sphere circumscribed or inscribed in the first thin wall portion 7, 8 of first or second half-capsule.

According to an embodiment, said flange ring 28 or 29 is toroidal in shape.

According to an embodiment, said flange ring 28 or 29 is formed with a folded portion of the free flange end edge 26 or 27.

According to an embodiment, said flange ring 28 or 29 is formed with a folded portion of the free flange end edge 26 or 27 with an overall toroidal volume shape.

According to an embodiment, said flange ring 28 or 29 is formed with a folded portion of the free flange end edge 26 or 27, which is made in one piece with said flange 13 or 14 and is shaped like a flange end curl 30 or 31.

This end curl 30 or 31 is not intended to interact with the extraction device or machine because it is not intended to deform to make a hydraulic seal between the capsule 1 and the extraction chamber of said extraction device or machine.

According to an embodiment, said flange ring 28 or 29 extends remaining completely inside the half-space delimited by a median capsule plane M where there is said thin wall portion 7 or 8 of half-capsule, forming said flange 13 or 14.

According to an embodiment, said flange ring 28 or 29 is formed with a folded portion of the free flange end edge 26 or 27, which is made in one piece with said flange 13 or 14 and is shaped like a flange end curl 30 or 31; said flange end curl 30 or 31 extends, remaining completely in the same half-space, delimited by a median capsule plane M where there is said thin wall portion 7 or 8 of half-capsule, forming said flange 13 or 14.

According to an embodiment, said flange end curl 30 or 31 extends from a flat flange portion 13 or 14 towards the half-space delimited by a median capsule plane M where the first thin wall portion 7 or 8 of first half-capsule lies.

According to an embodiment, said flange ring 28 or 29 extends, together with the flange 13 or 14, remaining substantially in the half-space delimited by a median capsule plane M and by said flange 13 or 14, from which it extends, opposite to where there is said thin wall portion 7 or 8 of half-capsule, forming said flange 13 or 14.

According to a general embodiment, said flange ring 28 or 29 is formed with a folded portion of the free flange end edge 26 or 27, which is made in one piece with said flange 13 or 14 and is shaped like a flange end curl 30 or 31; said flange end curl 30 or 31 extends, together with the flange 13 or 14, remaining substantially in the half-space, delimited by a median capsule plane M and by said flange 13 or 14, opposite to where there is said thin wall portion 7 or 8 of half-capsule, forming said flange 13 or 14.

According to an embodiment, said flange end curl 30 or 31 comprises an outer toroidal curl segment 32 and an inner toroidal curl segment 33, which is folded inside said outer toroidal curl segment 32.

According to an embodiment, said thin wall portion 7 or 8 of half-capsule and said outer toroidal curl segment 32 form a flange channel 34 with a flat bottom.

According to a general embodiment, said thin wall portion 7 or 8 of half-capsule and said outer toroidal curl segment 32 form, in a section containing the radial direction R-R, a segment of an outline having a power function with odd exponent.

According to an embodiment, said capsule 1 comprising two specular facing half-capsules 3, 4, in contact on a median plane M.

According to an embodiment, said capsule 1 comprising two specular facing half-capsules 3, 4, in contact on a median plane M, and where both half-capsules 3, 4 comprise a flange ring 28, 29; and where said flange rings are lifted, therefore not in contact with said median plane M.

According to an embodiment, at least one of said truncated poles 15, 16 is adapted to receive at least one piercing device 35 for injecting fluid into said capsule 1.

According to an embodiment, both said truncated poles 15, 16 are adapted to receive at least one piercing device 35 for injecting fluid into said capsule 1.

According to an embodiment, at least one of said truncated poles 15, 16 is adapted to receive at least one opening device 36 for allowing the extract to come out from the capsule 1.

According to an embodiment, both said truncated poles 15, 16 are adapted to receive at least one opening device 36 for allowing the extract to come out from the capsule 1.

According to an embodiment, said capsule 1 is adapted to be inserted into an extraction chamber of a system 55 for preparing a predetermined amount of beverage using an extractable product.

According to an embodiment, said capsule 1 is adapted to be inserted into an extraction chamber of a system 55 for preparing a predetermined amount of beverage using an extractable product in any polarity orientation, thus also inserted with inverted polarity of the truncated poles 15, 16 thereof.

According to an embodiment, a filter 37 is present in the inner half-chamber 9, 10, at least close to at least one of said truncated poles 15, 16.

According, a filter 37 is present inside the inner half-chamber 9, 10, at least close to at least one of said truncated poles 15, 16, which is adapted to receive at least one piercing device 35.

According, a filter 37 is present inside the inner half-chamber 9, 10, at least close to at least one of said truncated poles 15, 16, which is adapted to receive at least one opening device 36.

According, a filter 37 is present inside the inner half-chamber 9, 10, at least close to at least one of said truncated poles 15, 16, which is adapted to receive at least one piercing device 35.

According, a filter 37 is present inside the inner half-chamber 9, 10, at least close to at least one of said truncated poles 15, 16, which is adapted to receive at least one opening device 36.

According to an embodiment, said filter 37 separates extractable product 2 from said first thin wall portion 7 and/or 8, at said truncated pole 15 and/or 16.

In accordance with an embodiment, said filter 37 is disc-shaped.

According to an embodiment, said filter 37 is connected to said first thin wall portion 7 and/or 8.

According to an embodiment, said filter 37 is connected to said first thin wall portion 7 and/or 8 outside said truncated pole 15 and/or 16.

According to an embodiment, said filter 37 is connected to first thin wall portion 7 and/or 8 in a concave portion thereof.

According to an embodiment, said filter 37 comprises a filter edge 38 and said filter 37 is connected to the thin wall 7, 8 along said entire filter edge 38.

According to an embodiment, said filter 37 is made of a material being heat-saleable to the thin wall 7, 8.

According to an embodiment, said filter 37 comprises a filter edge 38 and at least said filter 37 is made of a material being heat-sealable to the thin wall 7, 8.

According to an embodiment, said thin capsule wall 5, 6 comprises a varnishing layer at least in the side thereof facing said first or second inner half-chamber 9, 10.

According to an embodiment, said filter 37 is made of a material suitable for gripping to the varnishing layer present in the thin capsule wall 5, 6 when it is subjected to heating, e.g., by heat-sealing. In other words and according to an embodiment, said filter 37 is sealed to the thin capsule wall 5, 6 melting a heat-sealing material of the thin capsule wall and allowing it to enter at least partially the structure of the filter 37 and anchor the filter 37 to the thin capsule wall 5, 6.

According to an embodiment, said filter 37 is made of a material comprising at least one cellulose based layer.

According to an embodiment, said filter 37 comprises a filter edge 38 and at least said filter edge 38 is heat-sealable to said varnishing layer.

According to an embodiment, said filter 37 allows extract to pass, but blocks extractable product particulate 2.

According to a general embodiment, a system 55 for preparing a predetermined amount of beverage using an extractable product 2 comprises a capsule 1 as defined in any of the above-described embodiments and an extraction apparatus 56 comprising a receptacle 57 for comprising said capsule 1, a piercing device 35 for injecting fluid into the capsule, and an opening device 36 for the extract to come out from the capsule.

According to an embodiment, said extraction apparatus 56 comprises a flange ring seat 57 adapted to receive the flange rings 28, 29 of said capsule 1.

According to an embodiment, said extraction apparatus 56 comprises a flange ring seat 57 adapted to receive the flange rings 28, 29 of said capsule 1 when the two half-capsules 3, 4 comprise specular flange rings 28, 29 overlapping along a direction orthogonal to a median capsule plane M.

According to an embodiment, said extraction apparatus 56 comprises a flange ring seat 57 adapted to receive the flange rings 28, 29 of said capsule 1 when the two half-capsules 3, 4 comprise flange rings 28, 29 placed side-by-side along a radial direction with respect to said first thin wall portions 7, 8 of half-capsule.

According to an embodiment, said extraction apparatus 56 comprises a flange ring seat 57 adapted to receive the flange rings 28, 29 of said capsule 1 when the two half-capsules 3, 4 comprise flange rings 28, 29 placed side-by-side along a radial direction with respect to said first thin wall portions 7, 8 of half-capsule.

According to an embodiment, said extraction apparatus 56 comprises a flange ring seat 57 adapted to receive the flange rings 28, 29 of said capsule 1 when the two half-capsules 3, 4 comprise specular flange rings 28, 29 overlapping along a direction orthogonal to a median capsule plane M.

According to a general embodiment, a method for extracting a beverage from a capsule 1 as defined in any of the above-described embodiments comprising an extractable product 2 when this capsule is inserted into a system 55 as defined in any of the above-described embodiments, comprising the steps:
once said capsule 1 has been inserted into said receptacle 57 of extraction apparatus 56, closing said receptacle 57 so as to pierce at least one of said truncated half-capsule poles 15, 16 with said piercing device 35 for injecting fluid into the capsule;
injecting fluid into said capsule 1 with said piercing device 35 for injecting fluid into the capsule.

According to an embodiment, there is provided the further step of injecting fluid into said capsule 1 with said piercing device 35 for injecting fluid into the capsule so as to increase the pressure of the fluid in said single inner chamber 25, so as to deform the opposite truncated pole 16, 15 until it interferes with said opening device 36 for the extract to come out from the capsule by opening the capsule and extracting the extractable product extract.

According to an embodiment, during the deformation, the opposite truncated pole 16, 15 and the opening thereof by said opening device 36 for the extract to come out from the capsule, said filter (37) remains deformed, but intact.

According to an embodiment, the pressure inside the capsule 1 reaches a value of between 5 and 12 bars.

According to an embodiment, during the closing of said receptacle 57, as it accommodates the capsule 1, said opening device 36 for the extract to come out from the capsule opens the opposite truncated pole 16, 15.

According to an embodiment, at least one of said truncated poles 15, 16 comprises a weakened pole portion 39, where the thin wall 7, 8 has a reduced and weakened thickness for allowing the opening with the interaction of the capsule 1 with at least one of said piercing device 35 for injecting fluid into the capsule and/or opening device 36 for the extract to come out from the capsule.

According to an embodiment, said capsule 1 is inserted into said receptacle 57 with any polarity, allowing the opening and extraction in any orientation it is inserted.

According to an embodiment, said capsule 1 is inserted into said receptacle 57 with a first truncated pole 15 facing said piercing device 35 for injecting fluid into the capsule and the opposite truncated pole 16 facing said opening device 36 for the extract to come out from the capsule, or with the opposite truncated pole 16 facing said piercing device 35 for injecting fluid into the capsule and the first truncated pole 15 facing said opening device 36 for the extract to come out from the capsule.

According to a general embodiment, a process for producing a half-capsule 3, 4 according to any one of the above-described embodiments includes the steps of
cutting a disc from a sheet of material adapted to make a thin capsule wall 5, 6 capable of mechanical resistance and substantially forming a barrier to oxygen and humidity;
deep drawing said discs forming in one piece a first thin wall portion 7, 8 delimiting an inner half-chamber 9, 10 which is substantially hemispherical and adapted to contain said extractable product 2 and, close to the greater dimension D thereof, or equatorial diameter of the inner half-chamber 9, 10, form a second thin wall portion 11, 12 in one piece with said first thin wall portion 7, 8 which bends to form an annular flange 13, 14 radially R-R and externally projecting away from said first thin wall portion 7, 8.

According to an embodiment, producing a flange ring 28, 29 at the end of said annular flange 13, 14 during the deep drawing step.

According to an embodiment, producing a pair of mutually identical half-capsules 3, 4.

According to an embodiment, the two half-capsules 3, 4 are deep-drawn so as to make a first flange ring 28 having smaller radial dimensions and a second flange ring 29 having greater radial dimensions and so that when the two half-capsules are facing the two flange rings 28, 29 are mutually arranged radially R-R side-by-side.

According to an embodiment, in a process for producing a capsule 1, there are included the above-described steps to obtain two mutually identical half-capsules 3, 4, and there is also included the step of coupling these two half-capsules 3, 4 arranging them facing each other and mutually specular to form a capsule 1.

According to a general embodiment, a capsule 1 for preparing a predetermined amount of beverage suitable for consumption using an extractable product 2, e.g., ground coffee, comprising a first and a second half-capsule 3, 4. Each half-capsule 3, 4 comprises a thin capsule wall 5, 6. Said thin capsule wall 5, 6 forms in one piece a first thin wall portion 7, 8 delimiting a substantially spherical shape inner half-chamber 9, 10. Said capsule wall 5, 6 close to the greater dimension D thereof forms, in one piece with said first thin wall portion 7, 8, a second thin wall portion 11, 12 which bends to form an annular flange 13, 14. Said two half-capsules 3, 4 are arranged facing each other and mutually specular and are joined to each other. At least one of said annular flanges 13 or 14 of said half-capsules 3 or 4 comprises a free flange end edge 26 or 27, which forms a flange ring 28 or 29, where said flange ring 28 or 29 comprises an overall ring thickness greater than the thickness of said portion of said annular flange 13 or 14, placed in contact with the adjacent half-capsule 4 or 3.

According to a general embodiment, a capsule 1 for preparing a predetermined amount of beverage suitable for consumption using an extractable product 2, e.g., ground coffee, comprising a first and a second half-capsule 3, 4.

Each half-capsule 3, 4 comprises a thin capsule wall 5, 6 capable of mechanical resistance, e.g., a thin wall, which can be pierced with a needle and if gripped with the hands, withstand a weak pressure, substantially forming a barrier to oxygen and humidity.

Said thin capsule wall 5, 6 forms in one piece a first thin wall portion 7, 8 delimiting a substantially hemispherical inner half-chamber 9, 10 adapted to contain said extractable product 2.

Said capsule wall 5, 6, close to the greater dimension D thereof, or the equatorial diameter, of the inner half-chamber 9, 10, forms a second thin wall portion 11, 12 in one piece with said first thin wall portion 7, 8 which bends to form an annular flange 13, 14 radially R-R and externally projecting away from said first thin wall portion 7, 8.

Said two half-capsules 3, 4 are arranged facing each other and mutually specular so as to contact at least one portion of said annular flange 13, 14 where they are joined to each other.

Said first thin wall portions 7, 8 have outlines with substantially identical volume.

At least one of said annular flanges 13 or 14 of said half-capsules 3 or 4 comprises a free flange end edge 26 or 27, which forms a flange ring 28 or 29, where said flange ring 28 or 29 comprises an overall ring thickness greater than the thickness of said portion of said annular flange 13 or 14, placed in contact with the adjacent half-capsule 4 or 3.

According to a general embodiment, at least one of said annular flanges 13 or 14 of said half-capsules 3 or 4 comprises a free flange end edge 26 or 27 forming a flange ring 28 or 29, where said flange ring 28 or 29 comprises a ring thickness, or height in the direction orthogonal to said median M separation plane between the two half-capsules 3, 4, which is greater than the height, or the height in the direction orthogonal to said median M separation plane between the two half-capsules 3, 4 of said portion of said annular flange 13 or 14, placed in contact with the adjacent half-capsule 4 or 3.

According to a general embodiment, said flange ring 28, 29 is an end portion of said flange 13, 14 folded in a U or a V.

According to a general embodiment, said flange ring 28, 29 is an end portion of said flange 13, 14 folded in an upside down U or an upside down V.

According to a general embodiment, said first thin wall portion 7, 8 is spherical cap-shaped.

According to a general embodiment, said first thin wall portions 7, 8 each forming a hemispherical cap outline and when they are mutually facing, they substantially form a sphere.

According to a general embodiment, both half-capsules 3 and 4 comprise said flange ring 28 and 29.

According to a general embodiment, both half-capsules 3 and 4 comprise said flange ring 28 and 29 and said flange rings 28, 29 are arranged specularly to each other.

According to a general embodiment, both half-capsules 3 and 4 comprise said flange ring 28 and 29 arranged one next to the other in the radial direction R-R.

According to a general embodiment, the radial direction is evaluated as the radial direction of the spherical outline of said first thin wall portion 7, 8 of first or second half-capsule, or of the sphere circumscribed or inscribed in the first thin wall portion 7, 8 of first or second half-capsule.

According to a general embodiment, said flange ring 28 or 29 is toroidal in shape.

According to a general embodiment, said flange ring 28 or 29 is formed with a folded portion of the free flange end edge 26 or 27.

According to a general embodiment, said flange ring 28 or 29 is formed with a folded portion of the free flange end edge 26 or 27 with an overall toroidal volume shape.

According to a general embodiment, said flange ring 28 or 29 is formed with a folded portion of the free flange end edge 26 or 27, which is made in one piece with said flange 13 or 14 and is shaped like a flange end curl 30 or 31.

According to an embodiment, said flange ring 28 or 29 extends remaining completely inside the half-space delimited by a median capsule plane M where there is said thin wall portion 7 or 8 of half-capsule, forming said flange 13 or 14.

According to a general embodiment, said flange ring 28 or 29 is formed with a folded portion of the free flange end edge 26 or 27, which is made in one piece with said flange 13 or 14 and is shaped like a flange end curl 30 or 31; said flange end curl 30 or 31 extends, remaining completely in the same half-space, delimited by a median capsule plane M where there is said thin wall portion 7 or 8 of half-capsule, forming said flange 13 or 14.

According to a general embodiment, said flange end curl 30 or 31 extends from a flat flange portion 13 or 14 towards the half-space, delimited by a median capsule plane M where the first thin wall portion 7 or 8 of first half-capsule lies.

According to a general embodiment, said flange ring 28 or 29 extends, together with the flange 13 or 14, from which it extends, substantially remaining in the half-space, delimited by a median capsule plane M and by said flange 13 or 14, from which it extends, opposite to where there is said thin wall portion 7 or 8 of half-capsule, forming said flange 13 or 14.

According to a general embodiment, said flange ring 28 or 29 is formed with a folded portion of the free flange end edge 26 or 27, which is made in one piece with said flange 13 or 14 and is shaped like a flange end curl 30 or 31; said flange end curl 30 or 31 extends, together with the flange 13 or 14, remaining substantially in the half-space, delimited by a median capsule plane M and by said flange 13 or 14, opposite to where there is said thin wall portion 7 or 8 of half-capsule, forming said flange 13 or 14.

According to a general embodiment, said flange end curl 30 or 31 comprises an outer toroidal curl segment 32 and an inner toroidal curl segment 33, which is folded inside said outer toroidal curl segment 32.

According to an embodiment, said thin wall portion 7 or 8 of half-capsule and said outer toroidal curl segment 32 form a flange channel 34 with a flat bottom.

According to a general embodiment, said thin wall portion 7 or 8 of half-capsule and said outer toroidal curl segment 32 form, in a section containing the radial direction R-R, an outline where at least one segment has a power function with odd exponent.

According to a general embodiment, said capsule 1 comprising two specular facing half-capsules 3, 4, in contact on a median plane M.

According to a general embodiment, said capsule 1 comprising two specular facing half-capsules 3, 4, in contact on a median plane M, and wherein both half-capsules 3, 4 comprise a flange ring 28, 29; and wherein said flange rings are lifted, therefore not in contact, with said median plane M.

In order to meet specific, contingent needs, those skilled in the art may make several changes and adaptations to the above-described embodiments and replace elements with others which are functionally equivalent, without however departing from the scope of the following claims.

Hereinafter, a used capsule emptying device 40 will be described and a method for emptying the used capsules of the used extractable product, separating it from the thin capsule wall 5, 6.

According to an embodiment, a used capsule emptying device 40 for separating used extractable product 2 from the thin capsule wall 5, 6 comprises a collection chamber 41, for example but not necessarily cup-shaped, comprising a collection chamber opening edge 44 delimiting a collection chamber opening 45 adapted to receive at least a first, or second, thin wall portion 7 or 8 of half-capsule, leaving the annular flange 13 or 14 of first or second half-capsule resting on said collection chamber opening edge 44.

Said collection chamber opening edge 44 comprises a collection chamber seat 50, close to the edge thereof opposite to said collection chamber opening 45, adapted to receive the first or second flange ring 28 o 29.

Said used capsule emptying device 40 further comprises a tubular cover 42 comprising a cover opening 46 adapted to receive a freely sliding piston 43.

Said cover 42 comprises an outer cover ring 47, adapted to fit outside around said collection chamber 44, and an inner cover ring 48, adapted to rest, with a cover edge 49 thereof against said collection chamber opening edge 44, so as to sandwich, between the edges 49 and 44, the annular flange 13 of first half-capsule and the annular flange 14 of second half-capsule of the used capsule 1 resting on the collection chamber 44.

Said cover 42 further comprises a cover seat 51 adapted to receive the second or first flange ring 29 or 28.

For example, said cover seat 51 is provided between said outer cover ring 47 and said inner cover ring 48.

Said piston 43 can slide in said cover opening 46 so as to interfere with a used capsule 1 and press it towards said collection chamber 44.

Below is a brief description of a method for separating the used extractable product 2 from the thin wall 5, 6 of the used capsule 1.

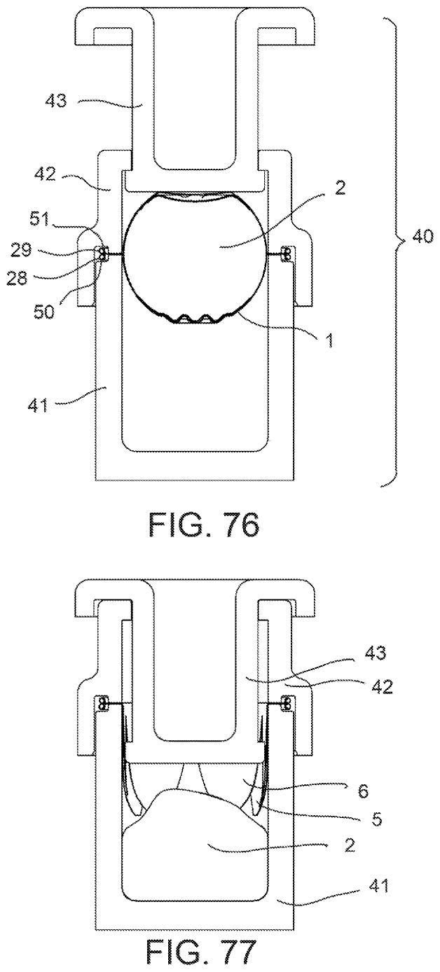

The figures show the three steps of emptying the used capsule 1. FIG. 76 shows the capsule 1 resting with the annular flange of the lower half-capsule thereof, e.g., the annular flange 13 of first half-capsule, on the collection chamber opening edge 44, arranging the flange ring thereof, in this case the first flange ring 28, housed in the collection chamber seat 50.

The cover 42 is fitted outside the collection chamber 41 and lowered until it brings the cover edge 49 thereof in abutment against the annular flange 14 of second half-capsule, sandwiching said annular flange 14 of second half-capsule against said annular flange 13 of first half-capsule and said collection chamber opening edge 44.

Then, the piston 43 telescopically slides in the seat thereof provided in the cover, i.e., the cover opening 46, until the truncated pole 15 of first half-capsule of the upper half-capsule, i.e., the second half-capsule 4, rests on the upper pole.

In FIG. 77 the piston 43 has completed the telescopic travel thereof, completely entering the cover 42 and crushing the used capsule 1 which, by virtue of the openings made therein by the opening device for the extract to come out from the capsule, tears the thin capsule wall, allowing the used extractable product to come out as the capsule 36 is gradually crushed and opened, releasing the used extractable product 2.

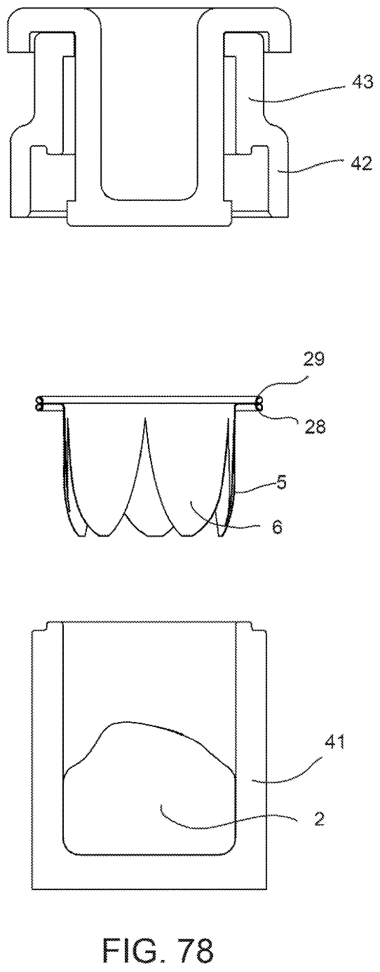

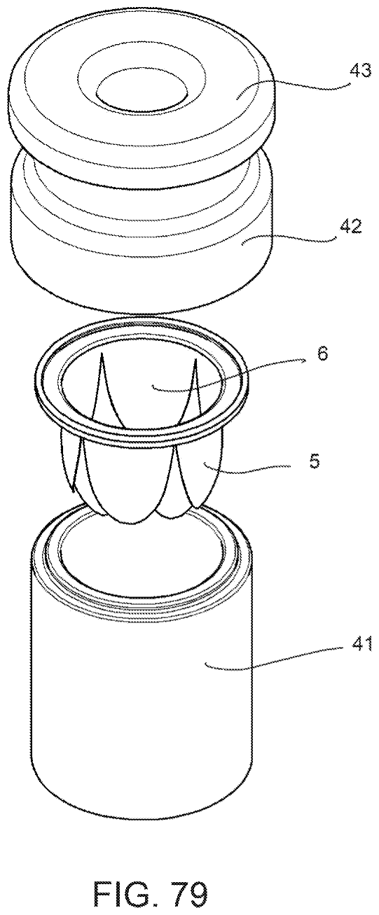

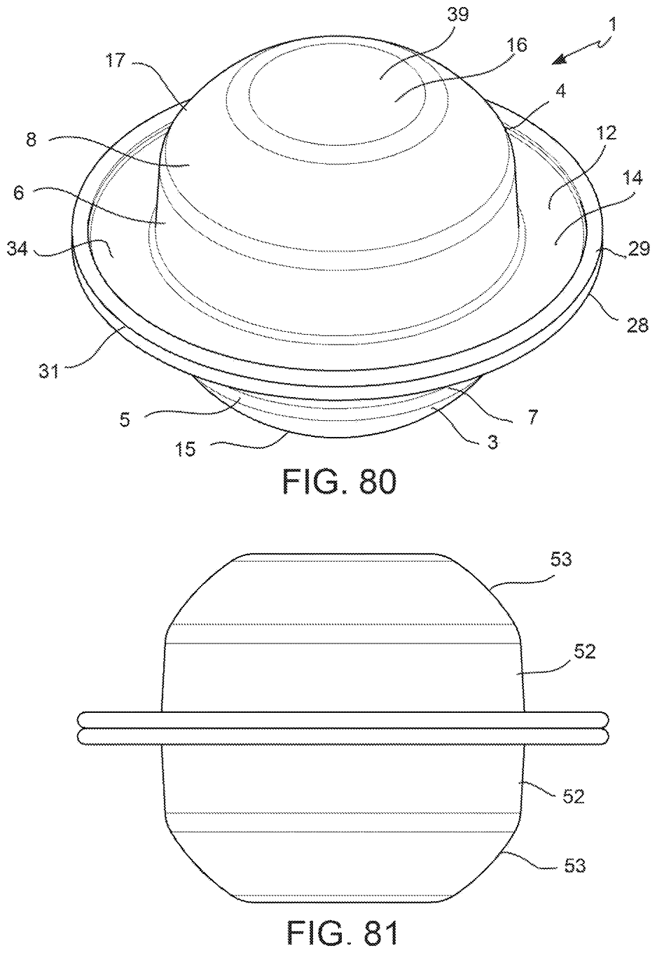

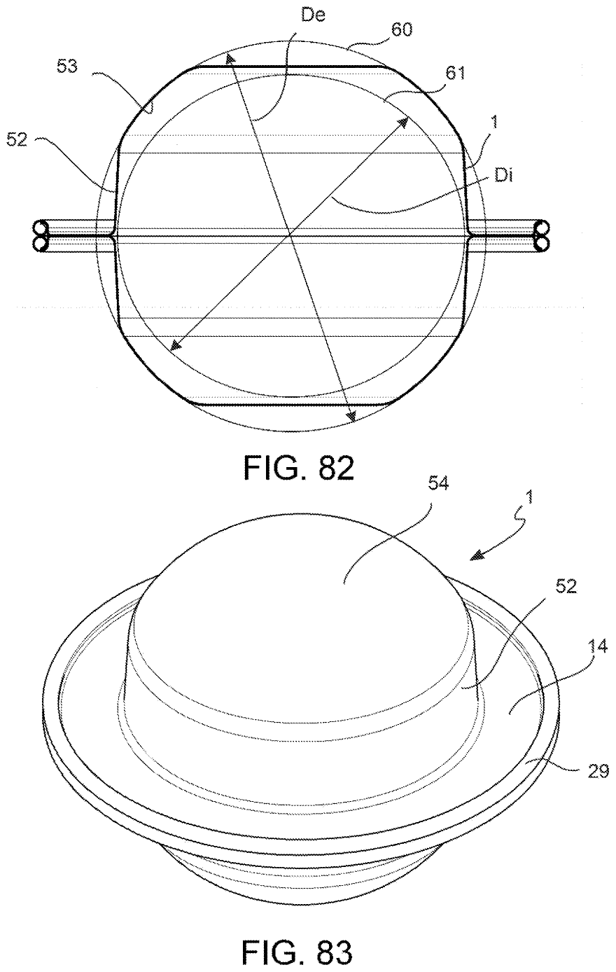

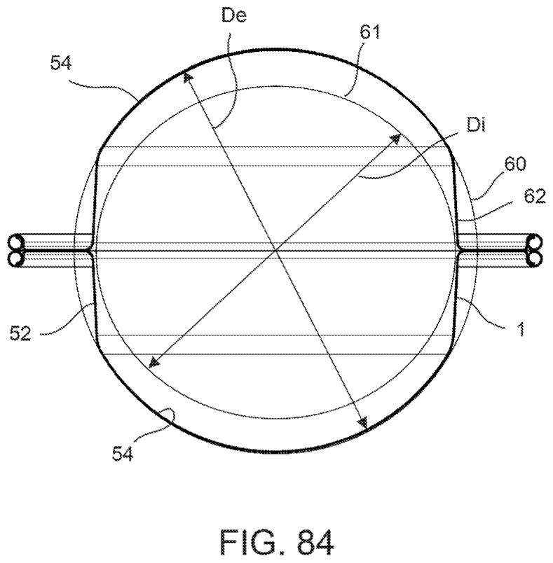

FIG. 78 shows the opening of the used capsule emptying device 40 and the extraction of the thin capsule wall, i.e., second thin capsule wall 6 and first thin capsule wall 5, emptied of the extractable product 2, which is collected at the bottom of the collection chamber 41.

According to an embodiment, a capsule 1 according to a constructional variant comprises the half-capsules 3, 4 which comprise a first thin wall portion 7 of first half-capsule and/or a first thin wall portion 8 of second half-capsule with a cylindrical wall segment 52 and a spherical cap wall segment 53 with truncated pole. The assembly of these cylindrical wall segment 52 and spherical cap wall segment 53 with truncated pole, i.e., this entire first thin wall portion, is inscribed in an outer hemisphere 60 and circumscribed in an inner hemisphere 61, where the difference in diameter between these two hemispheres 60 and 61 is less than 10%, preferably less than 5%.

According to an embodiment, a capsule 1 according to a further constructional variant comprises the half-capsules 3, 4 which comprise a first thin wall portion 7 of first half-capsule and/or a first thin wall portion 8 of second half-capsule with a cylindrical wall segment 52 and a complete spherical cap wall segment 54, i.e., without the truncated pole 15 or 16. The assembly of these cylindrical wall segment 52 and complete spherical cap wall segment 54, i.e., this entire first thin wall portion, is inscribed in an outer hemisphere 60 and circumscribed in an inner hemisphere 61, where the difference in diameter between these two hemispheres 60 and 61 is less than 10%, preferably less than 5%.

### REFERENCE SIGNS

1 capsule
2 extractable product or ingredient
3 first half-capsule
4 second half-capsule
5 first thin capsule wall
6 second thin capsule wall
7 first thin wall portion of first half-capsule
8 first thin wall portion of second half-capsule
9 first inner half-chamber
10 second inner half-chamber
11 second thin wall portion of first half-capsule
12 second thin wall portion of second half-capsule
13 annular flange of first half-capsule
14 annular flange of second half-capsule
15 truncated pole of first half-capsule
16 truncated pole of second half-capsule
17 thin wall portion with spherical outline
18 thin wall portion with spherical polyhedron outline and flat faces
19 thin wall portion bosses with spherical outline
20 thin wall portion grooves with spherical outline
21 meridian grooves of thin wall portion with spherical outline
22 parallel grooves of thin wall portion with spherical outline
23 spiral grooves of thin wall portion with spherical outline
24 thin wall portion steps with spherical outline
25 single inner chamber
26 first free flange end edge
27 second free flange end edge
28 first flange ring
29 second flange ring
30 first flange end curl
31 second flange end curl
32 outer toroidal curl segment
33 inner toroidal curl segment
34 flange channel between spherical portion and curl
35 piercing device for injecting fluid into the capsule
36 opening device for the extract to come out from the capsule
37 filter
38 filter edge
39 weakened pole portion
55 system
56 extraction apparatus
57 capsule receptacle
40 used capsule emptying device
41 collection chamber
42 lid
43 piston
44 collection chamber opening edge
45 collection chamber opening
46 lid opening
47 outer cover ring
48 inner cover ring
49 lid edge
50 collection chamber seat
51 lid seat
52 cylindrical wall section
53 spherical cap wall segment with truncated pole
54 complete spherical cap
55 system
56 extraction apparatus
57 capsule receptacle
60 outer hemisphere
61 inner hemisphere
C center
R-R radial direction
D sphere diameter of the inner half-chamber
M median capsule plane
H distance between truncated poles
De circumscribed or outer sphere diameter
Di Inscribed, i.e., inner, sphere diameter
h1 upper ring thickness
h2 flange thickness
L portion of said annular flange in contact with the adjacent half-capsule
Df flange diameter

What is claimed is:

1. A capsule for preparing a predetermined amount of beverage suitable for consumption using an extractable and/or soluble product, optionally the extractable and/or soluble product being ground coffee, the capsule comprising:
a first half-capsule and a second half-capsule;
wherein each half-capsule comprises a thin capsule wall capable of mechanical resistance and forming a barrier to oxygen and humidity;
wherein said thin capsule wall forms in one piece a first thin wall portion delimiting a substantially hemispherical inner half-chamber, adapted to contain said extractable and/or soluble product;
wherein said thin capsule wall, close to a greater dimension thereof, or equatorial diameter, of the substantially hemispherical inner half-chamber, forms a second thin wall portion in one piece with said first thin wall portion which bends to form an annular flange externally projecting away from said first thin wall portion in a radial direction;
wherein said first and second half-capsules are arranged facing each other and mutually specular so as to contact at least one portion of said annular flange where the first and second half-capsules are mutually joined;
wherein at least one of said annular flanges of said half-capsules comprises a free flange end edge forming a flange ring, and wherein said flange ring has an overall ring thickness greater than a thickness of said at least one portion of said annular flange placed in contact with the adjacent half-capsule.

2. The capsule of claim 1, wherein
said capsule comprises one or more of the following features:
said first thin wall portions have substantially identical volume outlines;
or wherein
at least one of said annular flanges of said half-capsules comprises a free flange end edge forming a flange ring, wherein said flange ring has a ring thickness which is greater than a height, or flange thickness, of said at least one portion of said annular flange, placed in contact with the adjacent half-capsule.

3. The capsule of claim 1, wherein
said flange ring is an end portion of said annular flange which is U- or V-folded;
or wherein
said flange ring is an end portion of said annular flange which is folded into an inverted U or an inverted V.

4. The capsule of claim 1, wherein
said first thin wall portion is shaped like a spherical cap;
or wherein
said first thin wall portions, each forming a hemispherical cap outline and, when facing each other, substantially form a sphere.

5. The capsule of claim 1, wherein both half-capsules comprise said flange ring.

6. The capsule of claim 1, wherein both half-capsules comprise said flange ring and said flange rings are arranged specularly to each other.

7. The capsule of claim 1, wherein
both half-capsules comprise said flange ring and said flange rings are arranged side-by-side in the radial direction, wherein the radial direction is defined by a radial direction with respect to the thin capsule wall which delimits the substantially hemispherical inner half-chamber;
or wherein
both half-capsules comprise said flange ring and said flange rings are arranged side-by-side in the radial direction, wherein the radial direction is evaluated as a radial direction of a spherical outline of said first thin wall portion of the first or second half-capsule, or of a sphere circumscribed or inscribed in the first thin wall portion of the first or second half-capsule.

8. The capsule of claim 1, wherein said flange ring is toroidal in shape.

9. The capsule of claim 1, wherein said flange ring is formed with a folded portion of the free flange end edge.

10. The capsule of claim 1, wherein
the capsule comprises one or more of the following features:
said flange ring is formed with a folded portion of the free flange end edge with an overall toroidal volume shape; or
said flange ring is formed with a folded portion of the free flange end edge, which is made in one piece with said annular flange and is shaped like a flange end curl;
or wherein
said flange ring extends remaining completely inside a half-space delimited by a median capsule plane where said first thin wall portion of the first or second half-capsule is present, forming said annular flange;
or wherein
said flange ring is formed with a folded portion of the free flange end edge, which is made in one piece with said annular flange and is shaped like a flange end curl said flange end curl extends remaining completely in a half-space delimited by a median capsule plane where there is said first thin wall portion of the first or second half-capsule forming said annular flange;
or wherein
said flange end curl extends from a flat flange portion towards a half-space delimited by a median capsule plane where the first thin wall portion of the first or second half-capsule lies.

11. The capsule of claim 1, wherein
the capsule comprises one or more of the following features:
said flange ring extends, together with the annular flange from which it extends, remaining substantially in a half-space delimited by a median capsule plane and by said annular flange, from which it extends, opposite to where there is said first thin wall portion of the first or second half-capsule, forming said annular flange;
or wherein
said flange ring is formed with a folded portion of the free flange end edge, which is made in one piece with said annular flange and is shaped like a flange end curl; said flange end curl extends, together with the annular flange, remaining in a half-space, delimited by a median capsule plane and by said annular flange, opposite to where there is said first thin wall portion of the first or second half-capsule forming said annular flange;
or wherein
said flange end curl comprises an outer toroidal curl segment and an inner toroidal curl segment, which is folded inside said outer toroidal curl segment;
or wherein
said first thin wall portion of the first or second half-capsule and said outer toroidal curl segment form a flange channel with a flat bottom;
or wherein
said first thin wall portion of the first or second half-capsule and said outer toroidal curl segment form, in a section containing the radial direction, an outline having a power function with odd exponent;
or wherein
said capsule comprises two specular facing half-capsules in contact on a median capsule plane;
or wherein
said capsule comprises two specular facing half-capsules in contact on a median capsule plane, and wherein both specular facing half-capsules comprise said flange ring; and wherein said flange rings are lifted, thus not in contact, with said median capsule plane.
